(19) United States
(12) Patent Application Publication
(10) Pub. No.: US 2026/0155050 A1
(43) Pub. Date: Jun. 4, 2026

(54) METHOD, APPARATUS, AND SYSTEM FOR USE IN DETERMINING AIRCRAFT WEIGHT TO FURTHER DYNAMICALLY TEST AND IMPROVE THE ACCURACY OF THE DETERMINED AIRCRAFT WEIGHT

(71) Applicant: C. Kirk Nance, Keller, TX (US)

(72) Inventor: C. Kirk Nance, Keller, TX (US)

(21) Appl. No.: 19/268,654

(22) Filed: Jul. 14, 2025

Related U.S. Application Data
(63) Continuation-in-part of application No. 17/992,163, filed on Nov. 22, 2022, now Pat. No. 12,359,961.
(60) Provisional application No. 63/282,137, filed on Nov. 22, 2021.

(51) Int. Cl. G08G 5/51; B64C 25/34; B64D 45/00; G01G 19/07

(52) U.S. Cl. CPC G08G 5/51; B64C 25/34; B64D 45/00; G01G 19/07

(57) ABSTRACT

A system and method are provided for determining a more precise and accurate total weight and center of gravity of an aircraft, with the ability to immediately test the accuracy of the previously determined total weight of the stationary aircraft. Additional capabilities include determining, then testing for accuracy, the individual weights supported at each respective landing gear strut. Sensors are used to measure the static weight of the aircraft, with subsequent comparison to a dynamic measurement of the weight of the aircraft, while the aircraft is in motion.

This application claims the benefit of: Patent application Ser. No. 17/992,163 filed Nov. 22, 2022; with Publication No. US 2023/0160739 published May 25, 2023; and Provisional Patent Application No. 63/282,137, filed Nov. 22, 2021 the contents of which each are incorporated, and by reference herein in their entirety. The contents of U.S. Pat. No. 10,859,431 issued Dec. 8, 2020; and U.S. Pat. No. 11,913,823 issued Feb. 27, 2024 are incorporated, by reference herein in their entirety.

### BACKGROUND OF THE INVENTION

### 1. Field of the Invention

The present invention relates generally to improving the accuracy in the determinations of aircraft weight, measured by an Onboard Weight and Balance System (“OBWBS”); and specifically to use of apparatus and methods to identify and reduce “unrealized” errors in the determination and application of pressure correction values, which have been previously stored within a computer's memory and look-up table; when applying the pressure adjustments to correct for frictional distortions in measured pressure as related to weight supported by an aircraft's telescopic landing gear, while the aircraft is stationary. To further identify any “pressure correction adjustment values” which are “subsequently” found to be in error, and the extent of those errors; and provide revised and more accurate pressure adjustment values for use on ensuing aircraft flights. Portions within this Background Of The Invention relate to use of prior art methods, providing more accurate weight measurements obtained, when the aircraft is in motion (reference: U.S. Pat. No. 10,859,431); adding the additional steps described herein: to apply the “immediately learned” adjustment values to subsequent measured pressures, when determining aircraft weight, when the aircraft is stationary. (reference: Publication No.: US 2023/0160739).

The methods and apparatus of the present invention may also be used to improve the accuracy of OBWBSs that monitor the deflection and yielding of aircraft landing gear load bearing structural components, which systems utilize stain-gauge sensors to measure the applied loads and associate weight supported.

### 2. Description of the Prior Art

For the safe operation of an aircraft, the weight of the aircraft must be determined prior to take-off. Airlines (also referred to as: FAA Part 121 “Air Carriers”) have strict departure schedules, which are maintained to maximize aircraft utilization each day. Today's airline operations typically do not place fully loaded aircraft upon scales as a means to measure the aircraft weight, and the distribution of that weight commonly referred to as the aircraft Center of Gravity (“CG”); prior to an aircraft's departure (“dispatch”) from an airport gate.

On any single day within the United States, airlines average 28,537 departures; where each of these air carriers must determine the weight and CG for each aircraft prior to departure. Airlines operate on very rigid time-schedules, where even a short departure delay occurring early in the day can have a ripple effect and create scheduling problems throughout the airline's remaining flight schedule. Aircraft “load planning” is a crucial part of keeping an airline operating on schedule. A scheduled aircraft departure will commence its load planning process up to one-year prior to the actual flight. Airlines do not offer ticket sales for a flight, more than twelve months prior to the flight. As each ticket for a scheduled flight is sold, the average passenger weight and average checked bag weight are allocated into a load planning computer program, continually updating throughout the year the “planned load” for that flight. Aircraft have a Maximum Take-Off Weight “MTOW” limitation. Airline load planning procedures use assumptions as to the weight of passengers and baggage loaded onto the aircraft, to stay below the aircraft MTOW limitation. Use of these average passenger and checked-baggage “weight assumptions” have caused Regulatory Authorities to establish curtailments to the aircraft's weight limitations, thus airlines operating these weight-curtailed aircraft no longer have the ability to generate additional revenue, which might be available from the higher (original) weight limitations established when that aircraft was initially Type Certified (TC′d).

An accurate and reliable OBW&BS has been an aviation goal for over 50 years. There are many prior art methods and designs for determining aircraft weight; many of these designs include the measurement of internal pressure within oleo-type telescopic landing gear struts. Alternate OBW&BS designs sometimes use strain-gauge sensors to measure deflection of aircraft load bearing components, in their determination of aircraft weight. There remains an industry desire to develop a method which deliverers an accurate aircraft weight measurement, while minimizing additional hardware and apparatus that increase the weight penalty, by adding weight to the airframe.

An aircraft is typically supported by plural landing gear struts. In many if not most cases, aircraft are supported by three landing gear struts. Landing gear struts are designed much like and incorporate many of the features of a typical telescopic shock absorber. The shock absorber of the landing gear strut utilizes internal guide-bearings to maintain telescopic alignments, and internal O-ring seals to retain highly pressurized fluids, of both hydraulic oil and compressed gas. The free telescopic movement of these internal bearings and seals are hampered by friction forces within the landing gear; with these frictional forces falsifying the measured pressures within the landing gear, as related to the actual weight supported.

Aircraft weight is transferred to and is supported by respective pressures contained within the landing gear struts. More simply said . . . “the weight of an aircraft rests upon 3-pockets of compressed gas.” The supported weight is assumed to be proportional to internal landing gear strut pressure, measured in “psi” (pounds per square inch). The aircraft landing gear strut can be used as an aircraft weighing scale if the measured strut pressure is corrected for “pressure distortions” caused by internal friction within the telescopic landing gear.

Aircraft operational weights are limited by Federal Aviation Administration “FAA” Regulation. The FAA is the Regulatory Authority which regulates the design, development, manufacture, modification and operation of all aircraft operated within the United States, and will be referenced along with the term “Regulatory Authority” to indicate both the FAA and/or any governmental organization (or designated entity) charged with the responsibility for either initial certification of an aircraft or modifications to the certification of an aircraft. Examples of Regulatory Authorities would include: European Aviation Safety Agency “EASA”, within most European countries; Transport Canada, Civil Aviation Directorate “TCCA”, in Canada; Agência Nacional de Aviação Civil “ANAC” in Brazil; or other such respective Regulatory Authority within other such respective countries.

FAA Regulations (provided in the Code of Federal Regulations) are the governmental regulations, which detail the requirements necessary for an aircraft to receive certification by the Regulatory Authority within the United States. These would be equivalent to such regulations within the Joint Aviation Regulations “JARs” which are used in many European countries.

Title 14 of the Code of Federal Regulations, Part 25 refers to regulations that control the certification of Air Transport Category aircraft (“Part 25 aircraft”). Part 25 aircraft include most of the commercial passenger aircraft in use today. For example, Part 25 aircraft include Boeing model numbers: B-737, B-747, B-757, B-767, B-777, B-787; Airbus aircraft model numbers include: A-220, A-300, A-310, A-320, A-330, A-340, A-350, A-380; etc.

FAA regulations allow for control mechanisms to assure Part 121 Air Carriers (being typical airlines) manage aircraft loading procedures, to confirm at the completion of the loading process that the aircraft load (weight) remains within the aircraft's certified forward and aft CG limits.

In particular:

### Title 14—Code of Federal Regulations:

### Part 121—695, Subparagraph (d)

### § 121.695 Load Manifest: All Certificate Holders

The load manifest must contain the following information concerning the loading of the airplane at takeoff time:
(a) The weight of the aircraft, fuel and oil, cargo and baggage, passengers and crewmembers.
(b) The maximum allowable weight for that flight that must not exceed the least of the following weights:
   (1) Maximum allowable takeoff weight for the runway intended to be used (including corrections for altitude and gradient, and wind and temperature conditions existing at the takeoff time).
   (2) Maximum takeoff weight considering anticipated fuel and oil consumption that allows compliance with applicable en route performance limitations.
   (3) Maximum takeoff weight considering anticipated fuel and oil consumption that allows compliance with the maximum authorized design landing weight limitations on arrival at the destination airport.
   (4) Maximum takeoff weight considering anticipated fuel and oil consumption that allows compliance with landing distance limitations on arrival at the destination and alternate airports.
(c) The total weight computed under approved procedures.
(d) Evidence that the aircraft is loaded according to an approved schedule that insures that the center of gravity is within approved limits.
(e) Names of passengers, unless such information is maintained by other means by the certificate holder.

The FAA guidance listed above for determining the take-off weight of an aircraft; is often referred to as the Load Build-Up Method (“LBUM”), and can be summarize as:
beginning with the aircraft OEW: “Operating Empty Weight” (a measured weight of the empty aircraft, which must be re-measured on 36-month intervals),
added to OEW: is the weight of the flight and cabin Crew (a known weight associated with the number of crew members supporting that flight),
added to OEW+Crew: is the weight of the Fuel (onboard fuel indicators measure and display the weight of the fuel),
added to OEW+Crew+Fuel: is the weight of the Cargo (cargo weight is measured before it is loaded),
added to OEW+Crew+Fuel+Cargo: is the weight of the in-flight Catering (galley-carts have a measured weight, and the number of galley-carts for each flight are determined before being loaded),
added to OEW+Crew+Fuel+Cargo+Catering: is the assumed weight of the passengers, with carry-on items (a “designated” average weight of a typical passenger, multiplied by the number of passenger names listed on the load manifest)
added to the OEW+Crew+Fuel+Cargo+Catering+Passengers: is the assumed weight of the checked baggage (the “designated” average weight of a typical checked bag, multiplied by the number of bags which are manually counted by ground services baggage personnel, and loaded onto the aircraft. Though checked bags are often weighed at the ticket counter, that weighing is done to establish pricing for any potential “heavy bag charges” which might be a couple of pounds over the respective airline's allowed limit; but that bag weight is not communicated to the load planners).
resulting in the total weight of a fully loaded aircraft.

All air carriers must have FAA approved procedures in place (“an approved loading schedule, often referred to as the: LBUM” described above) in which the air carrier will follow such loading procedures to ensure each time an aircraft is loaded, the load will be distributed in a manner that the aircraft CG will remain within the forward (“FWD”) and aft (“AFT”) CG limitations. The FAA and the specific air carrier develop these procedures, which are often referred to as “loading laws,” and when implemented define how the aircraft is loaded. Assurances that the loading laws maintain weight (and location of that weight) remain within the certified envelope, Regulators often require curtailments be applied to the weight, FWD and AFT limitations of the envelope.

When measuring the weight of an aircraft supported by oleo struts, the aircraft weight can be classified into two types. The first type of weight is commonly referred to as “sprung weight.” The sprung weight is the vast majority of the aircraft weight and is suspended above the 3-pockets of compressed gas, within the telescopic landing gear strut. The second type of weight is a much smaller amount of the total weight and is commonly referred to as “unsprung weight.” Unsprung weight is the weight of the landing gear components such as: brakes, wheels, tires, and axles; which are located below the pockets of compressed gas. The unsprung weight is virtually a constant and unchanging weight. Brake wear and tire wear are the only variations to unsprung weight; and in the consideration of the aircraft total weight, the changes in unsprung weight are a very minimal amount.

A method for determining the weight of the aircraft can be determined from the measurement of landing gear strut pressure if distortions in measured strut pressure, induced by internal friction, are identified and corrected. As an Example: when weight is added to an aircraft and thereby transferred to the landing gear, the landing gear strut should immediately begin to compress and the pressure within the telescopic strut should immediately increase, in direct proportion to the amount of applied weight.

This does not happen.

The weight applied to each strut will not be immediately transferred to the working pressure within the landing gear strut, but instead some portion of that weight is initially supported by internal friction within the landing gear, which is created by the rubbing of telescopically sliding components within the landing gear such as: internal guide-bearings, O-ring seals, gland nut, piston-wiper and piston-scraper; all rubbing against the surface of the strut's telescopic piston. The rubbing action between the telescopically sliding components of the landing gear strut, being its outer cylinder and inner piston, is often referred to as “frictional forces.” As weight is applied to the telescopic strut and before the strut begins to compress, these frictional forces within the strut will support the initially applied weight, creating a falsely low strut pressure measurement as related to the “true-weight” supported. The measured pressure within strut will remain falsely low, even with the addition of more weight; until enough additional weight overcomes the weight supporting force of the internal friction. Once enough weight has been added to overcome the friction, the strut will begin to compress and strut pressure will increase in direct proportion to the amount of additionally applied weight, but internal strut pressure will remain “falsely low” as compared to the true-weight supported; due to the distortions in strut pressure caused by internal friction. This internal friction can be characterized into two types. Static friction, which must be overcome before initial telescopic movement, and is often referred to as “breakout friction”; and dynamic friction, which is a lesser amount of friction, often referred to as “sliding friction” which is experienced after the telescopic piston has begun to slide into or out of the landing gear strut cylinder. Internal oil within the landing gear helps lubricate those traveled surfaces, thus dynamic friction values can often be lesser than the static breakout friction values.

A similar but opposite pressure distortion occurs, as weight is removed from the landing gear. Friction will tend to trap internal pressure within the strut until enough weight has been removed that the trapped internal strut pressure will become sufficient to overcome the forces of internal friction, allowing the strut to telescopically extend. Strut pressure will now be “falsely high” as related to the true-weight supported, caused by the friction restricting the strut's telescopic movement. After the “static” breakout friction has been overcome, the lesser “dynamic” friction will continue, but with lesser distortions to internal strut pressures, in relation to the amount of true-weight supported.

Aircraft onboard weight and balance systems, which use landing gear strut pressure to accurately determine aircraft weight, must apply a pressure adjustment value to correct for errors in the measured landing gear strut pressure caused by landing gear breakout friction. Landing gear breakout friction values do not remain constant. Typically, previously determined friction correction values for a particular set of landing gear strut are determined and recorded; but do not necessarily guarantee that earlier recorded correction values will be valid for the next time an aircraft weight is requested. The ability to determine, and further apply valid correction values for breakout friction errors may require adjustments to those correction values previously determined, recorded, and stored.

Measuring the oscillating range of respective strut pressures while the aircraft taxi, allows for the identification and measurement of internal frictional patterns in “real-time” allowing for a most recently available corrections value for pressure distortions caused by the ever-changing internal friction patterns, most often due to changes in current temperature, current humidity, and changes in the internal frictional characteristics within each strut due to the wear upon those continuously sliding telescopic components; and be immediately applied in the current aircraft weight determination.

As the aircraft is taxiing and strut pressures are recorded and monitored, oscillation patterns of high-peak pressure and low-peak pressure within the landing gear strut create a wave and the propagation of the wave's pressure values are recorded and tagged to corresponding accelerometer measurements. Hundreds of harvested and stored strut pressure measurements are recorded throughout the pressure oscillation waves, allowing for the identification of the range of “high-to-low-to-high-to-low” peak-pressure differentials, herein referred to as the “delta pressure” as the aircraft is taxiing at a constant weight.

A review of prior art (Publication No.: US 2023/0160739 still pending) friction values are monitored as the aircraft is taxiing, during variations in environmental conditions; and are matched and tagged to aircraft 3-axis acceleration, for further filtering to identify and remove distorted pressure measurements. US 2023/0160739 does not create a look-up table for pressure correction values, because the methods of this system provide a series of “real-time weight measurements” developed while the aircraft is in motion.

Continual measurements are made during the daily flight operations as the aircraft is taxiing with the landing gear tires rolling across the airport taxiway. The bouncing of the aircraft along the taxiway will exercise the landing gear struts forcing telescopic movement, and changes in the aircraft's 3-axis accelerations. Though the weight of the aircraft remains constant, the pressure within the telescopic strut will fluctuate up and down, caused by inertia from the vertical transfer of the aircraft's constant weight. Avoidance of the use of outdated and unreliable breakout friction values previously stored within a look-up table will insure more accurate aircraft weight determinations. Real-time measurements of delta pressures recorded from the aircraft in motion, eliminates potential and probable errors created by using previously recorded values within a look-up table; and currently assuming them as accurate breakout friction values to correct subsequent friction errors. Unrecognized changes in breakout friction will increase the error in weight measurements, when outdated friction data is used to correct strut pressure measurements.

In a search of other prior art, there are numerous OBW&BSs which measure the weight of a stationary aircraft, utilizing methods and apparatus for measuring landing gear strut pressure and the further use of look-up tables for application of corrections to measured pressure, as it relates to the amount for weight supported; from distortions in strut pressure cause by landing gear friction. An objective of the systems and methods described herein is to use the lessons-learned from measuring the weight of a moving aircraft, to increase the accuracy of a weight measuring system for a stationary aircraft.

Prior art's use of strut pressure to determine aircraft weight and balance can be divided into two basic strategies.

The first of these strategies use a method of pre-measuring the amount of breakout friction at the initial installation of the system's apparatus and hardware onto the aircraft and record a pre-measured friction value at each respective landing gear strut into a computer “long-term memory” look-up table, for later use in the determination of aircraft weight. Variations of this approach are well documented and reference may be made to:

U.S. Pat. No. 5,214,586-Nance, which teaches a method of an aircraft weight and balance system calibration process, with apparatus which utilizes a computer, including a look-up table memory for the storing and subsequent retrieval of previously measured landing gear strut breakout friction values.

U.S. Pat. No. 7,967,244-Long, which teaches a method of an aircraft weight and balance system calibration process, with apparatus which utilizes a computer, including a look-up table memory for the storing and subsequent retrieval of previously measured landing gear strut breakout friction values, which have been recorded beforehand, during the system's calibration process. Additionally, through a method of simulating added weight or load onto the aircraft, applied weight increases are measured, prior to any increase in strut pressure, and are subsequently related to an archived value for strut breakout friction values.

A second strategy for the measurement of strut breakout friction is the method attaching pumps, valves and actuators to the aircraft landing gear to “induce the exercising” of the aircraft's telescopic landing gear struts while the aircraft rests stationary, with the aircraft weight remaining constant. Forcing the strut to move telescopically allows for a real-time determination of strut “high and low peak pressure values” to correct for pressure distortions, as related to weight supported. The additional weight penalties and complexities for these types of added apparatus and their interactions with the aircraft's systems, have raised safety concerns; by the system penetrating into the existing aircraft's hydraulic control systems, and have made those types of systems undesirable to the airline industry. Variations of this approach are well documented, and reference may be made to United States Patents:

| | |
|---|---|
| # | 5,214,586 - Nance |
| # | 5,521,827 - Lindberg |
| # | 5,548,517 - Nance |
| # | 6,126,951 - Nance |
| # | 6,237,406 - Nance |
| # | 6,237,407 - Nance |
| # | 6,293,141 - Nance |

Other methods of the prior art, related to aircraft landing gear friction are described in: U.S. Pat. No. 6,032,090—von Bose; which teaches the additional art of exercising the landing gear strut with an auxiliary pump mechanism installed onto the aircraft to further measure both landing gear strut static and dynamic sliding friction. The prior art of von Bose measures strut friction of a stationary aircraft, at the gate, in real-time, with a mechanical pump and reservoir device to force strut movement and does not use any type of computer look-up table or memory to store and subsequently re-use strut seal friction values.

United States Patent Application Publication #US/2006/0220918-A1—Stockwell, teaches rotating landing gear strut O-ring seals within the housing of the strut cylinder, as a means to reduce landing gear strut seal friction, which is used to reduce frictional errors, in the measurement of aircraft weight.

U.S. Pat. No. 4,007,894—Hartel, teaches a method and apparatus for minimizing axial friction forces in a cylinder-piston shock absorber and further teaches rotating the bearing structure with respect to the cylinder and piston. Such rotation minimizes axial friction forces in the assembly, allowing the fluid pressure to assume a value accurately reflecting the axial load.

U.S. Pat. No. 4,979,595—Paton, teaches a fluid actuated friction damper with apparatus including a cylinder with an expandable piston assembly, made up of a piston having two spaced apart parallel end walls which form an annular chamber. A curved friction member is located between these edges in this opening and is pressed against the inside of the cylinder by an underlying flexible actuator ring.

Additional prior art has been developed, which eliminate the unwanted weight penalties of: hydraulic pumps, values and actuators; listing other methods related to monitoring various aspects of aircraft landing gear, which include:

| | |
|---|---|
| # | 7,193,530 - Nance |
| # | 7,274,309 - Nance |
| # | 7,274,310 - Nance |
| # | 8,042,765 - Nance |
| # | 8,543,322 - Nance |
| # | 8,565,965 - Nance |
| # | 8,565,968 - Nance |
| # | 9,045,237 - Nance |
| # | 9,927,319 - Nance |
| # | 10,089,634 - Nance |
| # | 10,295,397 - Nance |
| # | 10,859,431 - Nance |
| # | 11,410,183 - Nance |
| # | 11,416,871 - Nance |
| # | 11,913,823 - Nance |

When considering the methods described within this new invention, which offers improvements to the prior art; the methods described herein rely heavily on several methods taught within specific prior art. For convenience in the review of those examples, sections of those prior texts are included below:

Patent No. U.S. Pat. No. 10,859,431—Nance
Aircraft onboard weight and balance systems, which use landing gear strut pressure, as compared to weight changes identified by changes in weight measurements using strain-gauge sensors, which measure the axle deflection of the aircraft landing gear.
Landing gear strut seal breakout friction values do not remain constant. A previously recorded and stored breakout friction correction value for a particular landing gear strut does not necessarily mean that earlier recorded correction value will be valid for the next time an aircraft weight is determined from some future measurement of that landing gear strut pressure. The ability to determine, and further predict, an appropriate correction value for breakout friction errors require adjustments to currently recorded strut pressure measurements for the interrelationship of physical and environmental variations affecting the landing gear strut; at the time the value for the breakout friction correction is applied.
To illustrate landing gear strut breakout friction, strut pressure in relation to landing gear axle deflection will be discussed. The weight of the aircraft supported by the above-mentioned pockets of compressed gas is transferred down the landing gear strut to the landing gear axles, which bear the load and are supported by the landing gear tires. The differential in measured weight as determined by axle deflection, to the weight determined by strut pressure equals the amount of weight supported by the breakout friction. The weight supported by breakout friction can be converted into a pressure correction value by dividing the breakout friction weight value as determined by the axle deflection prior to pressure change, by an amount equivalent to the load supporting cross-sectional area (measured in square inches) within the strut. The results will determine the amount of a pressure correction value (measured in psi) which is then applied to the measured pressure value, to correct for pressure errors caused by breakout friction.
   Patent Publication No. US 2023/0160739—Nance
While the aircraft is moving on the ground, typically traveling along a taxiway, the aircraft hull will oscillate vertically. During the taxi-period, the telescopic landing gear struts are exercised by the weight of the aircraft bouncing atop the internal “gas-spring” within the landing gear; creating a corresponding oscillation wave of strut pressure measurements, identified by a range of high-peak pressures and an opposing range of low-peak pressures, produced by the unchanging weight of the aircraft transitioning upward then downward against the strut's internal gas pressure spring. Vertical movement of the aircraft is measured by a 3-axis accelerometer, as well as horizontal acceleration changes typically caused by pilot's applying engine thrust and/or applying the aircraft brakes. Horizontal acceleration from side to side is measured as “aircraft roll” when the aircraft is rocking back and forth between the two opposing main landing gear struts. Landing gear strut pressures will oscillate above and below a determined median pressure during this taxi-period, caused by the aircraft's changing vertical accelerations between the positive and negative vertical accelerations of the aircraft hull. As landing gear pressures are recorded, 3-axis accelerations of the aircraft hull are also measured and recorded. Respective pressure measurements are tagged and time-stamped with corresponding 3-axis acceleration measurements.
The oscillation patterns of high-peak pressure and low-peak pressure within the landing gear strut create a wave, as pressure values are recorded and tagged to corresponding 3-axis acceleration measurements. Hundreds of pressure measurements are recorded throughout the pressure oscillation cycles, allowing for the identification of the range of “high-to-low-to-high-to-low” peak-pressure differentials, herein referred to as the “delta-pressure” as the aircraft is taxiing at a constant weight. Avoidance of the use of outdated and unreliable breakout friction values stored within a “long-term memory” look-up table will insure more accurate aircraft weight determinations. Real-time measurements of delta-pressures eliminate potential and probable errors created by using previously recorded values; and currently assuming those as accurate breakout friction values to correct subsequent friction errors; when such “stale” assumed values cannot account for recent changes in frictional forces of landing gear components, caused by environmental effects such as temperature and humidity; nor changes in landing gear strut seal breakout friction patterns caused by atypical wearing of strut seal mechanisms and/or imperfections, pitting and scarring to the surfaces of the telescopically sliding strut piston, cause by the NLG tires lifting up debris along a runway, with that debris striking the front of both MLG pistons during the take-off and/or landing runs. Unrecognized changes in friction forces will increase the error in weight measurements, when outdated friction data is used to correct current strut pressure measurements.

The methods taught within this new invention provide processes to achieve the accuracies in determining the weight of an aircraft in motion; but applied when measuring the weight of a stationary aircraft.

### SUMMARY OF THE INVENTION

The invention described herein provides apparatus and methods to enhance the accuracy in determination of the weight of a stationary aircraft; when weight is measured by an OnBoard Weight and Balance System (“OBWBS”), for aircraft with either pressurized telescopic landing gear struts (“struts”) which “strut” pressures support the weight of the aircraft; or OBW&BSs which use strain-gauge sensors measuring deflection of aircraft load bearing components.

It is one object of the present invention to provide improvements for measuring aircraft weight, when using strut pressure measurements, and further determining and correcting for pressure errors induced by internal strut friction.

In attempts to contrast this new invention, to that of the prior art: Patent No. U.S. Pat. No. 10,859,431 issued to this inventor, which is sometimes characterizes as “Friction Prediction” the prior art uses previously determined friction patterns, to then extrapolate the pressure adjustment trend-line from some previous date, in attempts to predict a pressure adjustment value in hopes the adjustment value is correct for the current date, and hopefully is again correct on some future date. The prior art provides no ability to confirm the Predicted Friction pressure correction values will remain valid and correct for an extended period of time, days, months or years.

This new invention uses similar methods to measure and record friction patterns, then store within preferably, a “short-term memory” look-up table; or past data stored within a long-term memory look-up table that comprises both recently monitored data and older data; but continues further by comparing the just-applied pressure adjustments to each strut of a stationary aircraft, to an immediate measurement of the determined weights at each respective strut, as the aircraft begins to taxi away from the loading gate; further providing a method to validate if the just-applied pressure adjustment values, from the “short-term memory” look-up table, were correct or in-correct and if in-correct, by how much.

Prior art methodologies make the “assumption” that breakout friction values do not frequently nor appreciably change. While having no assurances of that the friction correction values will remain constant for a significant period of time, nor ability to determine when and how much the correction values might change.

The methods of this new invention assume the breakout friction values do have a tendency to change, thus use of the most recent pressure adjustment values available, recorded from the aircraft recently in motion, to provide a more accurate measurement of the weight for when the aircraft is stationary. New methods include applying recently-learned and better friction correction values, to improve the next requested weight measurement of the stationary aircraft; as opposed to potential use of “stale friction data” stored months earlier, and only within a “long-term memory” look-up table.

The invention described herein uses a variety of “strut data harvesting” sensors including: a pressure sensor to measure internal strut pressure, and in particular the range of internal pressure. Pressure sensors are used to identify strut telescopic movement, rate of telescopic movement, range of internal strut pressure in relation to rate and range of telescopic movement. Still other sensors are used to measure changes in environmental conditions including current external temperature, as well as internal strut temperature, and relative humidity surrounding the landing gear strut, which might affect telescopic fictional patterns including the pliability and texture of the compounds which make up the strut seals and internal guide bearings.

The new invention described herein, also employs the use of a variety of aircraft hull and landing gear strut data harvesting sensors including: horizontal groundspeed of the aircraft hull, inclination of the aircraft; and 3-axis acceleration for vertical and bi-directional horizontal movements; to better identify for a moving aircraft the current pressure adjustment values for friction, to subsequently apply those recent adjustment values to a stationary aircraft.

In accordance with another aspect, using time-stamped strut pressure measurements are identified for an aircraft in motion, which correlate to an oscillation pattern of wave propagation of the measured strut pressures, produced as the aircraft is taxiing horizontally and the aircraft hull oscillates vertically, and further identify strut pressure oscillations, generating ranges of high-peak pressures and low-peak pressures recorded along respective strut pressure waves. To determine from analysis of landing gear strut pressure oscillations patterns, applying the correction value, being equivalent to ½ of the high-low peak-pressures, are applied as pressure correction values to the landing gear strut pressure of a stationary aircraft.

In accordance with still another aspect, use of novel methods to determine and identify recently determined and more accurate pressure correction values, measured from an aircraft in motion, and continuously updating the respective pressure correction values, and progressively recording and storing the revised correction values within a computer look-up table.

To subsequently provide those more accurate friction correction values, when next requested from the look-up table for the weight measurement of a stationary aircraft. At such subsequent request for weight measurement of the stationary aircraft, use of these newly-learned breakout friction values, providing superior pressure adjustment values, as opposed to use of stale-data, previously stored within the look-up table.

It is another object of the present invention to provide a system to compile and trend measured aircraft landing gear strut breakout friction patterns identified from a moving aircraft, to verify the accuracy of stored correction values within a “short-term memory” look-up table; and when inaccuracies are identified, subsequently apply the recently learned and better pressure correction values when next measuring the weight of a stationary aircraft.

In attempts to better summarize the methods of this invention, a parallel analogy might be characterized by:
a student studying for a test=monitoring previous aircraft taxi-periods producing a more accurate determination of aircraft weight, to identify a respective strut pressure correction value, determined from analysis of landing gear strut pressure oscillations patterns, being equivalent to ½ of the high-low peak-pressures, to be applied as an increase to strut pressure of a telescopically compressing landing gear, or a decrease to pressure of a telescopically extending landing gear; when the aircraft is stationary.
the student taking the test=applying the determined pressure correction values to the measured strut pressures of a stationary aircraft.
the student's test being graded by an evaluator=as the aircraft departs from a gate and transitions from stationary to moving, measuring the aircraft weight using those more accurate weight measuring methods, compared to the previously determined weight of the stationary aircraft, to identify any difference, and if a difference is confirmed at a respective landing gear, determine a new and different friction correction value, which is more accurate than the initial correction value which had just been applied to the prior stationary aircraft.
the same student taking the test again (2^{nd} test)=the next time the aircraft is stationary (typically the next flight scheduled for that day) and an aircraft weight is requested, apply the most recently “learned” new pressure correction values to the respective landing gear measured pressure, while the aircraft is now stationary.
the same student's 2^{nd} test being graded by an evaluator=after applying the most recently learned pressure correction values, and as the aircraft transitions from stationary to moving; measuring the aircraft weight supported at each respective landing gear, then compared to the just determined weight at each respective landing gear of the stationary aircraft, to identify any greater or lesser differences; and if any differences are identified, determine a next-level and different correction value to be applied to the next weight request for the stationary aircraft, which shall be more accurate than the initial correction value applied to the prior 1^{st} test grading, of the stationary aircraft.
a 3^{rd} test and grading attempt, and a 4^{th}, and a 5^{th} and beyond, allow the learning methods to repeat and further repeat to improve the subsequent determinations of better and better pressure correction values, with improvements being demonstrated when the weight measurements of the stationary aircraft transition to more closely match with the most accurate weight measurements of a moving aircraft.

As more and more subsequent tests are graded by the aircraft in motion, and those test grading results allow the student to improve the accuracy on each subsequent test, provides similar methods to be used as a “learning tool” to improve the accuracy in determining a better correction in the landing gear strut pressure adjustment values. Often this “learning tool” is characterized as “machine learning” used in the initial AI (Artificial Intelligence) phases for evaluating and determining this specific landing gear's ever-changing frictional patterns and correction values.

When considering the B-737 aircraft having up to eight (8) flights per day, resulting in the re-taking of the same test, with the opportunity to refine the answers while taking the same test, up to two-hundred forty (240) times over a 30-day period; allows the strut pressure correction values to continuously improve. For aircraft making its initial flight of that day, which have not recently landed, the taxi-period for the aircraft moving to a gate for an initial loading of the day, can be used as the most recently determined strut pressure patterns.

One of the methods of the invention herein describes a process of tracking the friction characteristics of a particular landing gear strut, where that landing gear strut may be overhauled, installing new seals, previously harvested data from a particular landing gear strut will no longer be valid, where the methods of this new invention “immediately learn” the new friction patterns of a recently overhauled landing gear installed onto the aircraft, allowing the initial taxi-period of the aircraft from the maintenance hangar to re-learn the new friction values and be applied at the next request for the weight measurement of the stationary aircraft. During the few days required to re-learn the frictional patterns for an overhauled strut with new seals, the weight limitation for the aircraft may be slightly curtailed, until the re-learning process demonstrates subsequent static weight measurements are consistently demonstrated within the acceptable variance of the aircraft's immediately following dynamic weight measurements.

The invention herein offers improvements by using “most recently identified” friction correction values, as opposed to other systems which teach methods of strut pressure correction by creation of a look-up table, stored within a computer memory, of previously measured breakout friction values; which have been recorded months earlier; leaving those systems with potentially false assumptions that these historical breakout friction values have not changed due to internal bearing and seal wear, or environmental changes; and those look-up table values remain equivalent to any current strut breakout friction values; nor have any “in real-time” verification methods, as are described herein of identifying current strut pressure oscillation-pattern data from a moving aircraft as it approaches the airport loading gate, to further provide a superior adjustment value to correct for pressure distortions induced by frictional forces affecting the landing gear of a stationary aircraft; and to further test and verify these applied correction values are truly correct; and if incorrect record the identified differences during the current post-departure taxi-period, to modify the pressure correction adjustment values for a stationary aircraft, on subsequent departures.

The invention herein, also offers improvements to OBW&BSs using strain-gauge sensors measuring deflection of load bearing components, by using the same testing techniques of the weight determinations from the stationary aircraft, compared to weight determinations while the aircraft is in motion. Taxiing around the airport taxi-ways, at various headings, experiencing a variety of environmental factors, as well as having the ability to capture numerous weight measurements to filter and remove potential errors from issues including electronic noise within the system hardware components, applicable to most electrical systems; provides the need to have a most accurate OBW&BS. Even a 1/10^{th} of 1-percent weight error on a Boeing 777-300ER can recover as much as Seven Hundred Fifty pounds (750 lbs.) on each flight. Considering this aircraft typically makes 2 long-haul flights each day equates to One Thousand Four Hundred passenger-tickets per year; equating to a potential loss of revenue, just over Two Million Dollars ($2,000,000.00) per year. Recovery of even this least amount of weight error can accumulate to large sums over the 30-year typical life of the aircraft.

### BRIEF DESCRIPTION OF THE DRAWINGS

Although the features of this invention, which are considered to be novel, are expressed in the appended claims; further details as to preferred practices and as to the further objects and features thereof may be most readily comprehended through reference to the following description when taken in connection with the accompanying drawings, wherein:

FIG. 1 is a side view of a typical air transport category aircraft, with a tricycle type landing gear in the extended position, resting on the ground, with various components of the invention.

FIG. 2a is a rear view of a typical aircraft nose landing gear strut with various strut pressure measuring elements of the invention attached to the landing gear strut.

FIG. 2b is a rear view of a typical aircraft nose landing gear strut illustrating load deflection elements and deflection measuring sensors of the invention, attached to the landing gear strut.

FIG. 2c is a rear view of a typical aircraft main landing gear strut illustrating load deflection elements and deflection measuring sensors of the invention, attached to the landing gear strut.

FIG. 2d is a side view of a typical aircraft main landing gear strut with various strut pressure sensing elements of the invention attached to the landing gear strut.

FIGS. 3a, 3b, 3c and 3d are side views of a typical aircraft main landing gear strut, where various elements of the invention are attached to the landing gear strut and are identified on FIG. 3a; where FIGS. 3b, 3c and 3d further illustrate pressure differentials within the strut as it varies in telescopic extension and compression, as the aircraft moves horizontally along an airport taxiway or runway, at a constant weight.

FIG. 4 illustrates a comparison of oscillating waves created by measured landing gear strut high-peak pressures and low-peak pressures, to the corresponding wave relate to the vertical movement of the aircraft hull; where the strut pressure wave is a mirror image or “reversed reflection” of the oscillation wave of aircraft's measured vertical movement as the aircraft is taxiing, while sensors measure vertical acceleration.

FIGS. 4a, 4b and 4c illustrate data-streams of strut pressure measurements. FIG. 4a illustrates the “assumptions” that strut pressure oscillations are systematical. FIG. 4b illustrates on-aircraft field-testing, illustrating strut pressure oscillation pattern asymmetry. FIG. 4c illustrates the filtering and removal of identified pressure outliers, to a more-narrow band of pressure measurements, tagged to a near-neutral vertical acceleration.

FIG. 5 is an illustration of the aircraft in motion, having the taxiing aircraft shown as floating atop its pressurized landing gear, within a virtual cube of measured 3-axis acceleration.

FIG. 6 is a schematic diagram of the onboard Data Acquisition Computer Unit (“DACU”), with sensor inputs and software programs of this invention, to improve the accuracy in determining landing gear strut pressure correction values applied to the aircraft when stationary, through comparison to the more accurate pressure correction values determined while the aircraft is in motion.

### DETAILED DESCRIPTION OF THE PREFERRED EMBODIMENT

As described within the prior art, when an aircraft is stationary, the “static” landing gear strut seal and telescopic guide-bearing breakout friction values are significantly greater than the “dynamic” friction values, as determined while the landing gear strut oscillates through telescopic motion.

The challenge becomes, how to achieve the accuracy in the landing gear strut pressure correction values obtained while the aircraft is in motion, to pressure correction values being applied to that same aircraft, while being stationary?

The present invention offers improvements to prior art systems, which determine aircraft weight and balance, by measuring pressures within an aircraft's telescopic landing gear strut (“strut”). Enhancements described herein incorporate an “artificial intelligence” having methods within interrelated computer software programs, with capabilities to learn and subsequently re-learn, to further refine and re-refine through analysis of strut pressure patterns recorded while the aircraft is in motion; to develop more advanced strut pressure adjustment values, used to correct for the ever-changing breakout friction pattern of each respective strut; and provide a “most recent” and “more accurate” strut pressure correction value, used to modify and make adjustments to currently measured strut pressures, providing a more precise pressure value, related to the true-weight supported by a respective strut, for an aircraft which is stationary. Landing gear strut breakout friction is not a constant value. As landing gear age, friction values will change. Friction will also constantly vary from changes in the environment, such as temperature and humidity. Aircraft landing gear designs utilize a variety of exotic metal materials, of which different types of metals expand and contract differently at various ranges of temperature. The mating surfaces of the telescopically sliding components may create higher amounts of binding, as temperatures and moisture levels change. Friction values will also change due to wear on the mating surfaces of telescopic landing gear strut's sliding components such as internal guide bearings, piston O-ring seals, wiper ring, scraper ring, and the gland nut that holds it all together. Changes in friction are also caused by scarring on the chrome finish of the main landing gear strut piston from flying gravel and debris picked-up by the nose landing gear tire and thrown against the main landing gear strut at high speeds during the take-off and landing runs. Changes in friction are caused by corrosion of the strut piston which can leave scars from galling or blistering of the chrome finish. These and other factors will change the amount of breakout friction and leave any initially pre-programmed breakout friction correction values of the prior art, relying on potentially stale data, offering unreliable friction correction values leading into larger errors in the aircraft weight measurements.

While an aircraft is stationary, when additional weight is being loaded into that aircraft, before telescopic movement of the landing gear can commence, strut seal and internal guide-bearing “breakout friction” often characterized as “static friction” must be overcome before internal strut pressure can change. The static break-out friction is a higher friction value than the “dynamic friction” often characterized as “sliding friction” being the frictional forces experienced after the static friction has initially been overcome. The lesser frictional forces related to sliding friction are realized when the telescopic mating-components become internally lubricated, from the residue of a thin film of hydraulic fluid applied during telescopic oscillation; and can be identified when strut pressures are measured while the aircraft is in motion, during taxi-periods.

The learning methods of this new invention offer improvements and simplifications, by removing the strain-gauge sensors used to aide in measuring breakout friction, required to determine a better strut friction correction value. Patent No. U.S. Pat. No. 7,967,244 (Long) teaches similar methods of determining strut friction correction values; but instead of measuring axle deflection, Long teaches use of strain-gauge sensors measuring loads applied to the landing gear trunion-pins, which attach the landing gear to the aircraft. Though installing the load measuring sensors in a protected upper-area within the landing gear compartment may provide a location with better protection from “FOD” (foreign object debris) which can be lifted from the runway by the spinning tires, to strike the area of the sensor; there are other load bearing components, such as the landing gear drag-brace and side-brace, which can support portions of the loads, which might be assumed to be totally supported by the main landing gear trunion pin. The thought of having to completely remove the landing gear to replace a failed sensor bonded to the main landing gear trunion pin might create such expensive maintenance events to make the OBWBS less likely to justify its overall costs to maintain.

Patent No. U.S. Pat. No. 10,859,431 (Nance) and Patent No. U.S. Pat. No. 11,913,823 (Nance) teach the methods of determining strut friction correction values by comparison of initial weight changes measured by landing gear strut axle-deflection sensors, before any recognized changes in strut pressure; to determine a friction correction value.

Those methods using strain-gauge sensors attached to load bearing components of the landing gear, to measure the amounts of weight applied to a respective strut, prior to overcoming strut breakout “static” friction, identified when subsequent changes in strut pressure are measured. To further use that specific amount of change in supported weight, to determine a “pressure correction value” by each respective landing gear.

Methods described within this new invention provide improved weight correction values, including respective strut pressure adjustment values, to a stationary aircraft. These new methods offer improvements over Patent Publication No. US 2023/0160739, which can provide a more accurate weight determination from a stationary aircraft, to that of the accuracy of aircraft weight measurements while in motion This new methods further compare the results from the methods of US 2023/0160739 to the suggested a better pressure correction value, when comparing to the results from Patent No. U.S. Pat. No. 10,859,431. These new methods will: identify (“learn”) a respective weight correction value, to subsequently test the accuracy of the “immediately learned” pressure correction value, and by “immediately testing” the correction value against the subsequent correction value just identified during the immediate taxi-period from the moving aircraft; to further determine if the learned and further re-learned correction values determined from analysis of identified errors previously applied as pressure correction values from U.S. Pat. No. 10,859,431 to the stationary aircraft; in subsequently providing more accurate pressure correction values, by comparison of weights determined from the moving aircraft, then apply the learning to the subsequent same, but stationary aircraft.

The new methods of this invention use both the recorded weight and respective strut pressure patterns from the aircraft in motion, identifying the limits of peak-pressure ranges compared to the determination of mean pressure, to further determine a better friction correction value, to be applied to a stationary aircraft. The methods of this new invention further test the validity and accuracy of the just-applied pressure correction values, used in determining the weight of the stationary aircraft, by subsequently (within minutes) measuring the weight supported at each landing gear, as the aircraft transitions from stationary, to in motion; during the next taxi-period.

As the aircraft begins to taxi, and with further comparison to identify any weight differences between the pressure adjustment applied to the stationary aircraft, to that of the aircraft now in motion; to subsequently use those determined weight correction value differences to improve the weight correction values on a subsequent flight (next-hour, or next-day), to further apply better correction values for current load amounts and environment conditions, as may be similar to those currently recorded, with a “more robust” weight correction look-up table, which relies upon fully-tested and recently (if not immediately) determined weight correction values identified from each landing gear, by each landing gear's respective serial number.

Use of the tools provided within the methods of this new invention allows for the use of pressure sensing and strain-gauge hardware, updating sophisticate computer software programs, reinforced with additional “testing, learning and re-learning” software analytics, continually updating a set of “maturing look-up tables” cross-referenced to better identify a more accurate strut friction correction value. Further applying the current and “best known” correction values in the next requested aircraft weight determination for a stationary aircraft. To then immediately test those correction value assumptions as the aircraft begins its next taxi-period, to identify exactly how correct those applied correction values had been; and when identifying any amount of difference (error) in the previously applied correction values, to subsequently learn and re-learn, to further determine and identify an even more precise and future correction value, to be applied to the pressure measurements of the stationary aircraft. To then be further evaluated by comparisons using that more accurate weight determination, again subsequently re-tested when the aircraft transitions into motion.

To summarize this new technology, apparatus and methods used for continuous monitoring and measuring by various sensors include:
Strut pressure sensors
Range of current strut pressures
Internal strut temperature
Strain-gauge sensing of load bearing components
External temperature
External relative humidity
Aircraft 3-axis acceleration

Below is a list of the data recording events by the various landing gear sensors, used as sensory inputs to the strut pressure version of the system's artificially intelligent learning capabilities, where the system's software has the ability to automatically grow in its knowledge, data-base and look-up tables, to make more accurate determinations for subsequent breakout friction values, applied to a stationary aircraft, by measuring, monitoring and further trending changes in the just-applied corrections for breakout friction values to the stationary aircraft, as compared to the most current breakout friction values identified while the aircraft has transitioned into motion, and further update those most recently identified and more accurate “friction correction” values into the database, stored within the memory of the system's onboard computer:
After the installation of the apparatus and software onto the aircraft, the aircraft is allowed to taxi to determine, measure and record data to be stored within a look-up table, being the “initial” respective strut breakout friction value, as the system undergoes its initial fully automated calibration sequence.
As the aircraft then enters into daily flight operations, updates to the strut pressure patterns along with the vertical and horizontal acceleration patterns are made when continuous measurements are recorded of strut pressure while the aircraft is taxiing, to determine the strut pressure ranges as a function of aircraft weight, as compared to delta-pressure ranges as a function of breakout friction values during strut oscillation, to further compare to delta-pressure ranges in relation to dynamic friction; compared to those measured when the aircraft was initially calibrated. The computer will measure and record any and all changes in strut's respective delta-pressure ranges. Examples of variations in aircraft weight ranges include:
   Aircraft at highest weights and highest strut pressure ranges, as the aircraft departs for take-off, with full fuel.
   Aircraft at lower weights and lower strut pressure ranges, as the aircraft arrives after landing, with minimum fuel.
   Aircraft at lowest weight and lowest strut pressure ranges, as the aircraft is moved to a maintenance facility, while the aircraft is empty.

Examples of corresponding data streams which are compiled to create the “environmental conditions related to ranges in pressure” related to strut pressure changes include:
Continuous measurement of strut internal temperature as related to range of pressure peaks, at various pressure ranges subject to aircraft weight.
   Strut temperature and corresponding pressure data points are stored and used to generate interrelated look-up tables, for corrections to pressure values as related to specific temperature values.
Continuous measurement of relative humidity as related to range of pressure peaks, at various pressure ranges related to aircraft weight.
   Humidity and corresponding strut pressure data points are stored and used to generate interrelated look-up tables, for corrections to pressure values, as related to specific humidity values.
Continuous measurement of the amount of the aircraft hull's vertical acceleration as related to changes in the weight determination, and further used to measure breakout friction values.
   Vertical acceleration and corresponding strut pressure data points are stored and used to generate a look-up table for corrections to pressure values, as related to changes in the aircraft vertical acceleration of the upper portion of the landing gear which moves congruently with the aircraft, recognized by variations in vertical acceleration.
   Comparison of strut pressure oscillations, while identifying changes in the aircraft's vertical acceleration, allows the methods of the software to recognize strut telescopic compression and extension, to further monitor delta-pressure ranges of a strut, which has now had a thin film of the internal hydraulic oil applied to the exterior surface of the strut piston, which reduces the sliding friction; and any associated changes to the respective pressure correction value.
Continuous measurement of the angle of aircraft incline, to identify situations where side-loads could affect strut telescopic friction.
   Aircraft inclination angles and corresponding strut pressure data points are stored and used to generate a look-up table for corrections to pressure values, as related to potential side-loads that would alter breakout friction values.
Intelligent software re-starts the learning process after a landing gear strut has been overhauled, with installation of new seals, thus changing the previously stored breakout friction values.
Intelligent software re-starts the learning process after a landing gear strut has been re-serviced with fresh oil, thus changing the previously stored breakout friction values. The new oil will carry less suspended dirt and contamination, allowing better lubrication; thus, changing the breakout friction values.
Intelligent software and corresponding recorded data transfers with, or accompanies, the landing gear strut by strut serial number, in the event a particular landing gear strut is exchanged onto another aircraft.
Use of most recently collected data points (data from aircraft's most recent arrival and taxi to a gate) will identify the most similar environment when evaluating ranges of peak pressure recorded during recent taxi, current temperature within the strut and relative humidity; to be further used in the application of breakout friction correction values for the next flight. Alternatively, data can be recorded when an aircraft leaves a gate and taxis to the runway.

The current invention describes two prior art steps and three new method steps for use of information identified from an aircraft in-motion, to subsequently be applied to a stationary aircraft:
(1) determination of a pressure adjustment values, stored within a look-up table, to be applied to the stationary aircraft,
(2) application of the pressure adjustment value to the same stationary aircraft,
(3) determination of the validity/correctness of the just-applied pressure adjustment values, identified by comparing weights supported at each respective landing gear, as determined while the aircraft was stationary; to the weights supported by the same respective landing gear while the aircraft is now in motion, and
(4) application of the “lessons-learned” to identify the amount of error and apply a more precise strut pressure correction adjustment at the next request for a weight measurement, to that same aircraft when stationary,
(5) repeat steps 1-4 multiple times, to re-learn and identify better pressure adjustment values, from previously determined less precise pressure adjustment values; to determine and apply an more accurate pressure adjustment value to the same stationary aircraft.

A analogy to these methods might be to consider:
Step 1—a student studying for a 1^{st} test,
Step 2—the student taking the 1^{st} test,
Step 3—the 1^{st} test immediately being graded,
Step 4—the student then allowed to review the graded 1^{st} test, to identify any errors found within the answers from that completed 1^{st} test.
Step 5—then 1-hour later, the student is allowed to re-take a 2^{nd} and identical test, but now using the information received from reviewing the errors identified from the grading of the 1^{st} test, to correct those prior errors, and apply better answers to the 2^{nd} test.
Steps 6 thru 100—to further allow the student to see the 2^{nd} test graded, finding fewer errors; and using the “lessons learned” to take a 3^{rd} test, and then a 4^{th} test, and multiple subsequent tests; until little to no errors are found during subsequent gradings of the tests.

As more and more subsequent tests are graded by the aircraft in motion, and those graded test results allow the student to improve the accuracy on each subsequent test, provides similar methods to be used as a “learning tool” to improve the accuracy in determining a better correction in the landing gear strut pressure adjustment value.

Typically, the measured weight of an aircraft when it lands, is often considered as “throw-away-data.” Upon landing, the safety of the aircraft at take-off and while in-flight, has concluded. The landing weight of the aircraft, being the take-off weight less the fuel burned during flight, has no relevant value to the safe operation of the aircraft.

On the contrary, the methods of this new invention find that landing weight information some of the most important data to be used. As the aircraft completes a flight and taxi to the gate, the measured and recorded frictional forces within each respective landing gear strut are the most recent values available, as well as similar environmental conditions; to be used for corrections for friction errors in measured pressures within each respective landing gear, on the very next flight.

The strut pressure, as well as deflection of load bearing component, methods of this new invention provide the “near-accuracies” of weight measurements, available only with a moving aircraft; but being applied to the same but stationary aircraft.

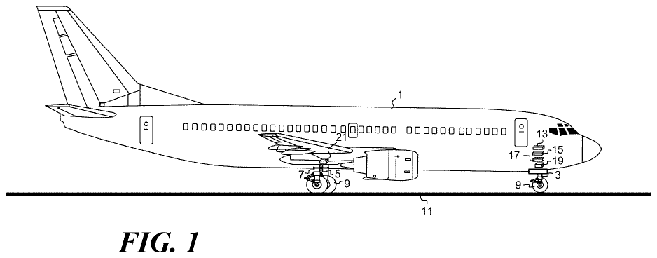

Referring now to the drawings, wherein like reference numerals designate corresponding parts throughout the several views and more particularly to FIG. 1 thereof, there is shown a typical Boeing 737 air transport category aircraft 1, with tricycle landing gear configuration consisting of a Nose Landing Gear (“NLG”) 3, and two identical Main Landing Gears (“MLGs”), including a left-MLG 5 and a right-MLG 7 (both MLGs positioned at the same location longitudinally along the aircraft, but shown in perspective view for this illustration). Landing gear 3, 5 and 7 support and distribute the weight of aircraft 1 through tires 9 which are resting on the ground 11. Electronic components, which together are used in this invention and attached to aircraft 1 are a data acquisition computer unit (“DACU”) 13, an inclinometer 15, a 3-axis accelerometer 19 positioned above and near NLG 3 and a 3-axis accelerometer 21 positioned above and near MLGs 5 and 7, which either or both accelerometers 19 or 21 transfer data to DACU 13 to further process and measure horizontal movement of aircraft 1 over the ground 11; and a temperature/humidity sensor 17. In efforts to reduce the number of system components, NLG accelerometer 19 and MLG accelerometer 21 can be removed from the system hardware, if aircraft acceleration data can be collected from the aircraft's 1 existing onboard inertial guidance system (existing inertial guidance system not shown) which provides 3-axis acceleration data. A slight degradation is system accuracy may occur with the elimination of NLG accelerometer 19 and MLG accelerometer 21, each being located at the respective landing gear positions, but may be considered negligible in efforts to offset and reduce system hardware complexity.

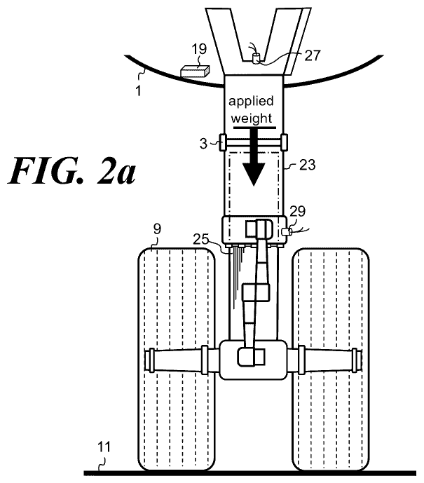

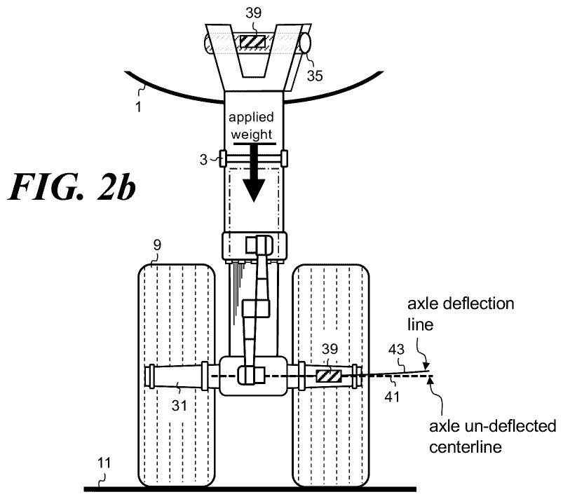

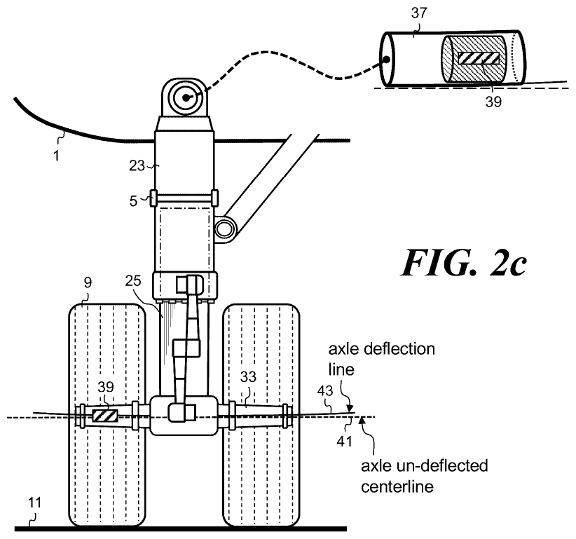

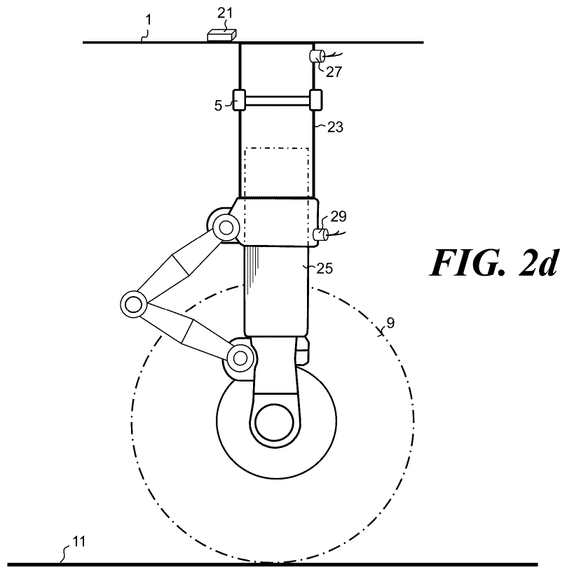

Referring now to FIG. 2a, there is shown a rear view of an aircraft 1 telescopic oleo NLG strut 3 with tire 9, which distributes supported aircraft weight onto the ground 11; further illustrating landing gear strut cylinder 23, in which strut piston 25 moves telescopically. Pressure within upper region of telescopic strut 3 is measured and continually monitored by a commercially available pressure sensor 27, which incorporates a temperature probe affixed to the pressure sensing element of pressure sensor 27, in contact with the working pressure and working temperature within NLG strut 3, herein referred to as the upper pressure/temperature sensor 27. NLG 3 has a second access to the working pressure within strut 3, typically known as the hydraulic fluid drain port. Lower pressure sensor 29 can be installed to provide redundancy in strut pressure measurements. Though lower pressure sensor 29 is shown, it is not required; as upper pressure sensor 27 can adequately provide the continuous monitoring of NLG 3 internal pressure.

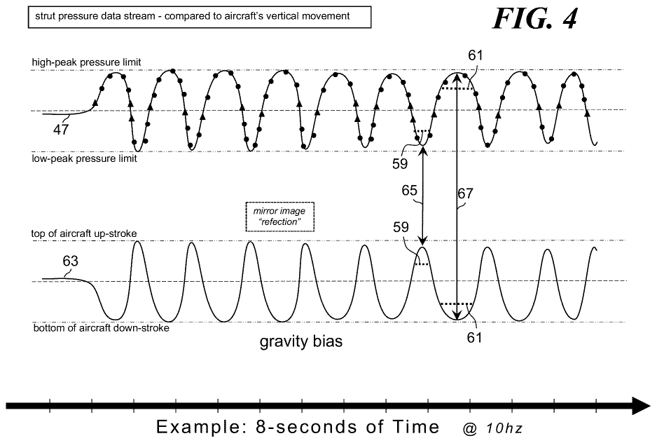

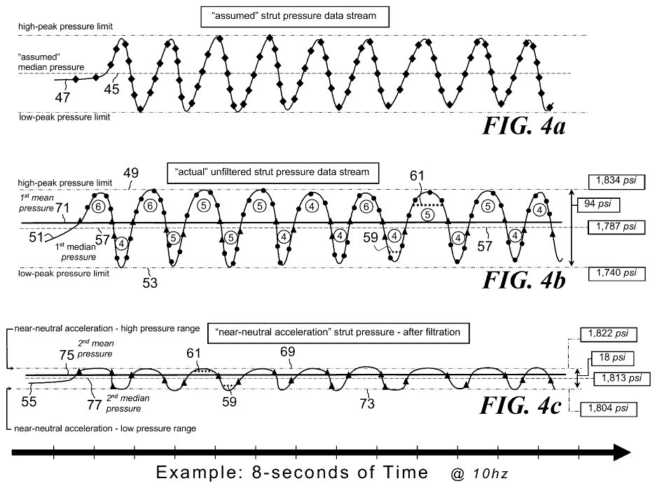

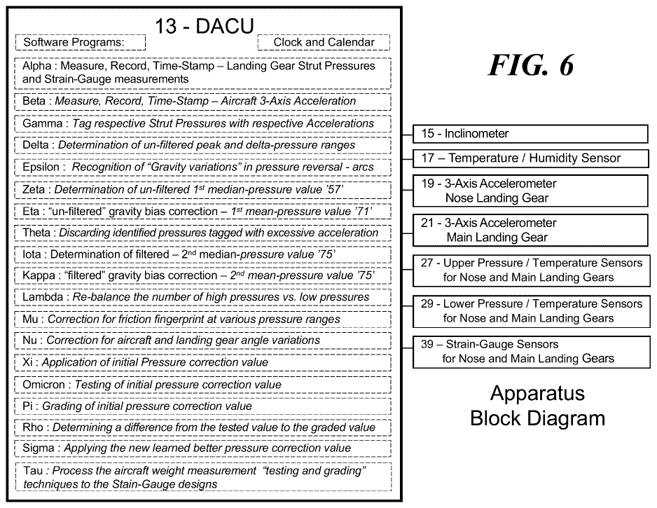

3-axis accelerometer 19 is attached to aircraft hull 1, to monitor changes in vertical and horizontal movement of aircraft 1 at the NLG 3 position. The changes in vertical movements of aircraft hull 1 are measured and recorded as positive or negative g-forces (+g or −g). Pressure measurements recorded from pressure/temperature sensors 27 and 29, along with multi-axis acceleration measurements recorded from 3-axis accelerometer 19 are time-stamped and respectively tagged to identify their respective correlations, by DACU 13 (shown in FIG. 1) and software algorithms described in FIGS. 4a-4c and FIG. 6.

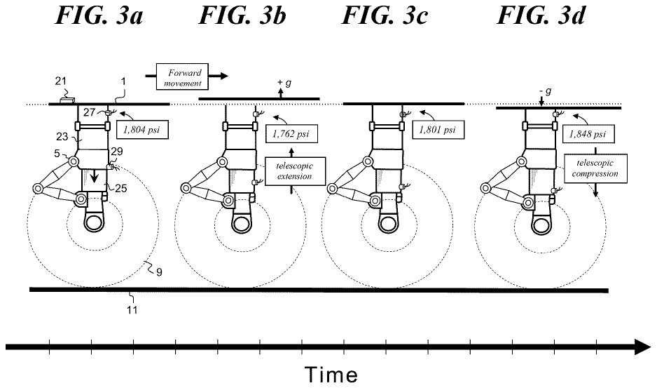

In consideration of FIGS. 3a, 3b, 3c and 3d; along with FIGS. 4, 4a, 4b, and 4c; which incorporate certain methods of the prior art developed by this inventor, shown within Publication No.: US 2023/0160739 for determining the weight of an aircraft in motion; and methods shown within Patent No. U.S. Pat. No. 10,859,431 for determining the weight of a stationary aircraft; the new and additional methods described and shown within FIG. 6 of this new invention, provide significant improvements to features of those in the prior art.

Referring now to FIG. 2b, there is shown a rear view of LG strut 3. Weight carried by NLG 3 is supported by tires 9, with the weight transferred to axle 31. Axle 31 will deflect as weight is applied, and is illustrated by the dashed axle un-deflected centerline 41 when compared to the solid axle deflection line 43. Changes in the deflection of axle 31 from changes in the amounts of supported weight are measured by strain-gauge sensor 39. Changes in the measured signal from strain-gauge sensor is communicated to DACU 13 (shown in FIG. 1)

Referring now to FIG. 2c, there is shown a rear view of MLG strut 5 illustrating the common use of sensors, as attached to NLG 3 (shown in FIGS. 2a and 2b).

Referring now to FIG. 2d there is shown a side view of MLG strut 5 with attached upper pressure sensor 27 and lower pressure sensor 29, continually measuring pressure associated from weight loads applied to MLG 5, with MLG accelerometer 21 measuring vertical movement of the aircraft 1 hull, while aircraft 1 is in motion during taxi.

Referring now to FIG. 3a, there is shown a side view of a typical aircraft telescopic MLG strut 5, again identifying strut piston 25, which moves telescopically within cylinder 23. Strut cylinder 23 is attached directly to and moves congruently with aircraft hull 1. Aircraft hull 1 and landing gear strut cylinder 23 being connected are both monitored by 3-axis accelerometer 21 which measures vertical movement, further identifying telescopic changes of strut 5; horizontal-longitudinal movement identifying groundspeed of aircraft 1; and horizontal-lateral movement identifying roll and sway of aircraft 1 while moving along ground 11; as well as other instruments used on aircraft 1 (not shown) which measure groundspeed. Pressure/temperature sensors 27 and 29 measure internal pressure and temperature within MLG 5.

Referring now to FIGS. 3b, 3c and 3d there are shown examples of a continuation from FIG. 3a where aircraft 1 has begun to taxi and move horizontally, as illustrated by the “Forward movement” box with a horizontal arrow. As aircraft 1 begins to taxi, over the ground 11; the aircraft weight supported by the pockets of compressible gas (which works as an internal spring contained within the telescopic strut 5), such spring will cause aircraft 1 to move vertically upward and downward, causing the internal strut pressure to oscillate with increases and decreases in strut pressure. Though the aircraft weight remains constant, the inertia of the aircraft weight traveling over a sometimes-uneven taxi-way surface, will cause internal strut pressure to change, generating a pattern of pressure oscillations between high-peak and low-peak pressure values. This upward and downward movement of aircraft 1 will transition to compression and extension of telescopic strut 5 and is further illustrated by increasing and decreasing internal strut pressure, as aircraft 1 moves horizontally along the surface of ground 11. DACU 13 algorithms (shown in FIG. 6) identify and tag respective pressure measurements to corresponding vertical and horizontal acceleration measurements from multi-axis accelerometer 21. After aircraft 1 has begun to taxi and continues to taxi at a steady and constant speed with that taxi-speed remaining unchanged, strut pressure measurements taken during that steady speed of horizontal movement can further determine a stabilized horizontal acceleration value of Og or near-net Og tagged to each pressure measurement.

As aircraft 1 moves upward and downward, with the compression and extension of piston 25 within cylinder 23; pressure/temperature sensors 27 and 29 measure the varying pressure and temperature within strut 5: 1,786 psi, →1,740 psi, →1,792 psi→1,834 psi respectively, as accelerometer 21 measures the vertical movement of aircraft 1. During aircraft 1 taxi, the “delta pressure”, being the difference in pressure between the high-peak pressure (1,834 psi) and the low-peak pressure (1,740 psi), within strut 5 is measured. The full delta-pressure range of 94 psi is determined (shown in FIG. 4b).

Referring now to FIG. 4 the primary objective of this FIG. 4 is to provide a better visualization for the comparison of the two taxi-graphs shown herein, and illustrate the mirrored, thus “reversed” pattern generated during the vertical movement of the aircraft hull as it bounces up and down, while rolling along a taxiway; to the oscillating pattern of the strut pressure measurements.

While the aircraft weight remains unchanged, changes in measured strut pressure are experienced as the aircraft is taxiing. Increases to the “vertical elevation” of the aircraft hull yields decreases in measured strut pressure. Reversal or decreases in the “vertical elevation” of the aircraft hull causes the telescopic struts to compress, yielding increases in measured strut pressure.

Referring again to FIG. 4 there is shown in the upper example, a taxi-graph illustrated as oscillating wave 47 of the plotted pressure measurements from the landing gear strut. High-peak pressures and low-peak pressures, are measured by pressure/temperature sensor 27 (shown in FIG. 2). Each pressure measurement is indicated along the propagation of pressure wave 47, by either Round (●) or Triangle (▴) shaped symbols (more fully described below and in FIG. 4b).

Shown in the lower example, is a taxi-graph illustrated as oscillating wave 48, corresponding to aircraft vertical movement; as it transitions from the upward stroke to the downward stroke, while the aircraft is moving horizontally. Wave 48 is a mirror or “reflected” image of wave 47. Comparisons of wave 47 to wave 48 offer a better visualization of the corresponding actions, while strut pressures are increasing upwards along wave 47, the aircraft is moving downward, and progressing through the lower region of wave 48.

Corresponding patterns illustrated in the two opposing and reflected wave comparisons, identify a more-rounded reversal through the high-pressure peak regions of wave 47, illustrated by the longer horizontal dotted-line 61; and directly corresponds with the aircraft's downward vertical movement, applying more load and pressures onto the strut, and illustrated in wave 47, having a corresponding more-rounded reversal in aircraft vertical movement and illustrated by the longer horizontal dotted-line 61.

During the aircraft up-stroke movement, shown along the upper region of aircraft acceleration wave 48 finds a more-narrow arc in the reversal of aircraft's vertical movement and is illustrated by a shorter dotted-line 59, which corresponds to the shorter dotted-line 59 in the lower region of strut pressure wave 47.

Double-arrow line 65 points to the comparison of the forces of the Earth's gravity applied against upward movement of the aircraft, inducing sharper reversals in the strut's lower-pressure regions of wave 47 as the aircraft rises, reflected against the corresponding reversals in the aircraft's upward vertical acceleration in the corresponding and mirrored upper regions of wave 48, as the aircraft transitions from an up-stroke in vertical acceleration to the beginning of the down-stroke in vertical acceleration. Double-arrow line 67 points to a similar comparison of the forces of the Earth's gravity, struggling against the transition from the aircraft's downward movements into upward movement, inducing more-rounded reversals illustrated by a longer dotted-line 61 in the high-pressure regions of wave 47, and the corresponding more-rounded arc in aircraft vertical acceleration illustrated by a longer dotted-line 61 shown in wave 48, while the aircraft transitions from down-stroke to up-stroke in vertical movement.

In the Example shown, pressure measurements are recorded at a rate of 10 measurements per second, resulting in eighty (80) pressure measurements recorded over an 8-second period of time. Other speeds of measurement sampling rates, for pressure and acceleration may be selected, depending upon the desired number of respective measurements, when considering the further filtering of “outlier pressure measurements” which shall be fully described within FIGS. 4a, 4b, and 4c.

Referring now to FIGS. 4a, 4b and 4c, there are shown examples of taxi-graphs of strut pressure oscillation waves, for strut pressure measurements recorded over an 8-second period of time. Though there is a large amount of information shown within these series of taxi-graphs, it is helpful to review them together, and through the transition and filtering of pressures measurements, to remove pressure outliers; allowing refinement into a tighter band of wave 55 (shown in FIG. 4c) of the non-rejected pressure measurements, which pass the acceleration filtering process, with those filtered pressure measurements subsequently averaged into single mean-pressure value 75 proportional to the true-weight supported.

Individual strut pressure measurements, shown along the taxi-graph in FIG. 4a are indicated by Diamond shaped (♦) symbols populated along oscillating wave 47, and are tagged with corresponding changes in vertical acceleration, as the aircraft is taxiing.

In separate taxi-graphs (not shown) for those other landing gear struts, respective and corresponding strut pressure measurements are tagged with changes in “horizontal” acceleration, for both the longitudinal and lateral directions, of the aircraft as it is taxiing. Similar filtering is done to identify and remove pressure outliers, in further efforts to allow only those pressure measurements which are not distorted by excessive acceleration, be used in the final weight computations,

The series of individual pressure measurements are indicated along the respective pressure wave, of oscillating lines 47, 51 and 55, with various symbol shapes:
FIG. 4a—Diamond-shaped (♦) symbols are used to indicate and tag all pressure measurements with acceleration values.
FIG. 4b—Round-Dot (●) symbols are added and used to “re-indicate” identified pressure measurements, which are then re-tagged due to identification with excessive “positive or negative” vertical acceleration.
FIGS. 4b and 4c—Triangle-shaped (▴) symbols are used to further “re-indicate” identified pressure measurements, which are re-tagged with lesser or a near-neutral or near-net-zero vertical acceleration.

In the Examples shown: all pressure measurements are tagged and shown within vertical acceleration ranging from +0.08 g, 0.00 g, −0.08 g. Additional evaluations performed by re-running the same strut pressure data, through a more restrictive filtering range from +0.02 g, to −0.02 g; finds the more aggressive filtering range resulting with only 16 of the 800 data points recorded, passing all of the filtering screens. When running the strut pressure data at the filtering range from +0.08 g, to −0.08 g; the pressure data finds a more porous filtering, allowing over 500 of the 800 data points passing through the filtering screens; but when using the broadened filter ranges, the system struggled in maintaining the desired accuracy. Further re-runs of the pressure data have shown a vertical acceleration range of +0.04 g, to −0.04 g to be the preferred and acceptable vertical acceleration range. Other acceleration ranges may be determined as acceptable, depending upon the system accuracy and/or data volume requirements.

Referring again to FIG. 4a, previous assumptions have the pressure oscillations shown as oscillating wave 47 of the taxi-graph and would be expected to have a symmetrical pattern of pressures, rising to a relatively sharp reversal at the high-pressure peaks, then falling to a corresponding sharp reversal at the low-pressure peaks.

Referring again to FIG. 4b, recent observations recorded from actual B737-700 on-aircraft field testing reveal a different oscillation pattern, which is shown by pressure wave 51, where the assumed sharp reversals were not generated on the high-pressure side of the wave. The best way to characterize what the testing has shown is: “Earth's gravity will bias the pressure oscillation patterns, to the high-pressure side of the total pressure average” as the aircraft moves downward (with a gravity assist) applying more load and higher pressures, for a slightly longer period of time, onto each landing gear.

During the taxi-period, as the aircraft initially moves vertically downward, compressing the landing gear strut and increasing the internal strut pressure; the strut pressure increases to a level that the downward inertia of the aircraft weight can no longer allow further strut compression. The increased strut pressure will force the aircraft to reverse directions and move back upwards, with a corresponding decrease in strut pressure.

In the taxi-graph Example shown as FIG. 4b, an oscillation pressure wave 51, identifies the high-peak pressure upper-range limit, shown by the upper-horizontal dashed-line 49, measured at 1,834 psi. The low-peak pressure lower-range limit is shown by the lower-horizontal dashed-line 53, measured at 1,740 psi. Initially, high-pressure peak values and low-pressure peak values are averaged, to identify a 1^{st} median-pressure of 1,787 psi and shown by dashed-line 57, which progresses along the centerline of pressure wave 51. The “un-filtered” peak-pressure limits identified along wave 51 create a “delta-pressure” range of 94 psi.

Subsequently, all pressure measurements (not just the peak-pressure limits) recorded throughout the entire pressure wave 51 are averaged to refine and determine a 1^{st} mean-pressure value, shown by horizontal line 71, to identify an upward shift from the 1^{st} median-pressure 57. The upward shift in average pressure shown by 1^{st} mean-pressure 71 is caused by the effects of Earth's gravity, pulling the aircraft downward, causing the compressing landing gear to generate a greater number of pressure measurements during a slightly longer period of time, resulting in that greater number of pressure measurements being above 1^{st} median-pressure 57, when compared to the number pressure measurements below 1^{st} median-pressure 57, measured over an identical period of time.

On-aircraft testing has identified the symmetry in pressure reversals from the high-pressures to the low-pressures are not the assumed sharp reversal patterns (shown in FIG. 4a); but instead, the force of Earth's gravity tends to hold the aircraft down for a longer period of time, and inhibits the aircraft from an immediate reversal upwards, thus generating a more-rounded pressure reversal or “arc” which is identified within the high-pressure ranges. With a rapid-rate (10 hz) of recording pressure measurements, it has been discovered (shown in FIG. 4b) that a greater number of the high-pressure measurements are captured, through the broader and more-rounded curve in the pressure oscillations, on the high-pressure side the 1^{st} median-pressure 57; compared to the number of low-pressure measurements recorded when the aircraft moves upward through the sharper reversals through the lower sections of the pressure oscillation curve 51. As the aircraft moves upward, and strut pressures reduce; gravity again tends to bias the pressure patterns by inducing a sharper pressure reversal arc through the low-pressure measurements below the 1^{st} median-pressure 57. This “asymmetry” on the high-pressure range of wave 51 accumulates a greater number of high-pressure measurements compared to the number of measurements within the low-pressure range, along wave 51. The greater number of high-pressure measurements broadens the reversal curve, illustrated by the longer dotted-line 61 within the arc of the high-pressure curve; and the lesser number of low-pressure measurements sharpens the reversal curve, illustrated by the shorter dotted-line 59 within the arc of the low-pressure curve.

Referring again to FIG. 4b there is shown Examples of strut pressures recorded along wave 51 at a rate of 10 hz (as used herein with respect to recorded strut pressures, the term “10 hz” refers to ten measurements per second). As pressure within the landing gear oscillates over an 8-second time period, eighty (80) pressure measurements are recorded and tagged with corresponding acceleration values. In the Example shown: fifty-nine (59) of the pressure measurements are re-tagged with Round-Dot symbols, as having either excessive positive or negative acceleration, thus not located within the near-neutral acceleration band of pressures (further described in FIG. 4c), The fifty-nine (59) Round-Dot re-tagged pressure measurements are classified as “pressures outliers” and are to be discarded; resulting in only twenty-on (21) of the Triangle symbol, re-tagged as acceptable pressure measurements remaining.

Referring now to FIG. 4c there is shown a tighter range of “non-discarded pressures” which form oscillating wave 55, made up of the twenty-one (21) Triangle symbol pressure measurements re-tagged as “near-neutral” positive and negative vertical acceleration. These near-neutral acceleration re-tagged pressure measurements reside within this more-narrow range of pressures between the reduced high-pressure range limit shown by the upper-horizontal dashed-line 69, having a measured pressure of 1,822 psi. The low-peak pressure range limit is shown by the lower-horizontal dashed-line 73, having a measured pressure of 1,804 psi. High-pressure peak values and low-pressure peak values are averaged to identify a 2^{nd} median-pressure of 1,813 psi and shown by dashed-line 77, shown passing along the centerline of pressure wave 55. The re-tagged as “filtered” pressures identified along wave 55 create a significantly reduces oscillation pressure range of 18 psi as the delta-pressure range. The reduced number of pressures, by those re-tagged as near-neutral or near-zero-acceleration, are all further averaged to identify an even more “filtered” but slightly elevated 2^{nd} mean-pressure 75. Though 2^{nd} mean-pressure 75 might be only a few psi greater than 2^{nd} median-pressure 77; applying these few psi to a much larger aircraft such as the Boeing 777 can reduce the errors in weight computations by thousands of pounds. Reducing the number of pressure outliers, resulting from frictional distortions and associated excessive accelerations; reduces the influences which degrade the weight measurement process, thus increases the accuracy of the final weight computations.

The re-tagged as “filtered” pressure measurements results in a more-narrow delta-pressure range of 18 psi; as opposed to the “un-filtered” pressure oscillation delta-pressure range of 94 psi (shown in FIG. 4b). Reducing the range between high-peak pressure to low-peak pressure, reduces those pressure measurements directly associated with the friction error, and thereby reducing the friction error increases the accuracy of the weight measurement while the aircraft is in motion. As the aircraft continues to taxi throughout the remaining 52-seconds of a 1-minute data capture (continued 52-seconds Example: not shown), an additional one hundred fifty-seven (157) “non-discarded” near-neutral, and near-zero-acceleration pressure measurements are collected. Additional 1-minute periods of taxi-time generate similar one-hundred-fifty plus (150+) filtered pressure measurements, allowing numerous cycles of pressures to be recorded, averaged, and further re-averaged into a more precise pressure value, near-net of landing gear strut seal friction distortions; with those fully refined pressure measurements averaged into a single pressure value, used in the algorithm to determine a more precise pressure value associated with the current true-weight supported, then the pressure value is multiplied times the load supporting surface area within the landing gear strut cylinder; to further determine a sprung-weight value supported by a respective landing gear strut.

Beyond the effects of changes in acceleration, as strut pressures increase; broader reversal curves shown by dotted-line 61 are seen in the higher-pressure ranges, when compared to the sharper reversal curves shown by dotted-line 59 in the lower-pressure ranges. These differences are also influenced by the increases and decreases in frictional forces caused by the deflection of the pliable composite materials used in the manufacturing process of landing gear O-ring seals. The frictional force value (herein referred to as the: “friction-fingerprint”) provides a direct correlation of strut pressure to the true-weight supported, when measured while the aircraft is in motion.

An alternate method to identify the specific amount of pressure distortion caused by a friction-fingerprint is revealed by re-running each pressure oscillation wave and removing the acceleration and identified pressure asymmetry corrections described in FIGS. 4, 4a, 4b and 4c; which removal of those corrections allows for the comparison of the difference between the prior filtered results to that of the unfiltered results, which difference further helps to identify the initial frictional force value and friction-fingerprint for a specific strut. Identification of the determined pressure differences help in the methods of this new invention to provide a more accurate, respective strut break-out friction and sliding correction values, to be applied to the respective landing gear strut pressures, of a stationary aircraft while loading (additional description provided within FIG. 6).

Considering the measurement sampling rates of ten samples per second (10 hz), and with a typical 7-minutes of aircraft taxi-time per departure at higher strut pressures, and a similar 7-minutes of taxi-time upon landing, at lower strut pressures; repeating this process over a 120-day period allows for 1,008,000 repetitions of the friction-fingerprint identification process for each landing gear strut. With the extremely large number of data-points supporting this process, the statistical leveraging of 1,008,000 identified frictional force values, when averaged into a single value, allow for a very refined value to be used for subsequent frictional correction offsets for a respective landing gear. The frictional force values are revised and updated into a short-term memory look-up table, as the values are recognized to have changed, because landing gear seal wear will change the frictional force value over time. Each landing gear strut is typically overhauled on a 10-year cycle. The friction-fingerprint profiling process will restart upon the landing gear overhaul with installation of new seals.

Referring again to FIG. 4c there is shown that the non-discarded pressure measurements would be assumed to all align near the 1^{st} mean-pressure 71 (shown in FIG. 4b) or 2^{nd} median-pressure 77 (shown in this FIG. 4c); but depending upon the prior direction from the transition of the telescopic strut piston, from either extending or compressing; the frictional-drag effects of the “lesser” dynamic/sliding seal friction as the piston continues in a first telescopic direction; to that of the increased frictional drag effects experienced when overcoming the “greater” static/break-out seal friction as the piston movement reverses to a second telescopic direction; will place any near-neutral or near-net-zero vertical acceleration tagged pressure variations further “above or below” the 2^{nd} median-pressure 77. Averaging only those re-tagged as filtered pressure values from this more-narrow band of pressures, which are unaffected by the reversal in strut direction from compression to extension, shown by wave 55, reduces the total number of pressure values, by the amount of those discarded higher and lower pressure measurements associated with the full range of delta-pressure measurements, which are then averaged and shown by the slightly elevated 2^{nd} mean-pressure 75; thus reducing the potential friction-error band, and increases the accuracy of the weight measurement, while the aircraft is in motion.

As a point of reference, with the Boeing 737 aircraft used as the example herein, having for each MLG a load supporting surface area of 38.44 square inches, and for the NLG 11.02 square inches; the more accurate weight measurement generated with better pressure corrections for internal strut seal friction within the combined MLGs and NLG equating to 1,813 psi−1,787 psi=26 psi, equating to 999.44 lbs. for the left-MLG; and with that amount doubled to account for the right-MLG, and further increased by 10% to account for the NLG; totals a more accurate weight determination by 2,199 pounds. The 2,199 pounds of error equates to the weight of 11 passengers, along with their carry-on items, being miscounted.

Referring again to FIG. 4b there is shown an “alternate method” to filter pressure measurements and correct for the Earth's gravity bias, which typically affect aircraft while taxing at heavier weight ranges and resulting in disproportionally heavier weight determinations than the true-weight of the aircraft. The gravity bias causes for a greater number of high-pressure measurements to be applied to the overall average of all pressures. Subsequent to the 1^{st} median-pressure 57 being determined, a count is taken for the number of pressure measurements, which are identified as greater than the 1^{st} median-pressure 57; and a parallel count is taken for the number of pressure measurements identified to be less than the 1^{st} median-pressure 57. These separate counts are illustrated by the “numerals within circles” as Examples: \textcircled{4} \textcircled{5} \textcircled{6} placed inside the arc of each of the pressure oscillation curves, identifying the number of recorded pressure measurements associated with each section of the pressure wave 51. The total number of pressure measurements recorded during the first segment of wave 51, and identified above the 1^{st} median-pressure line 57, is determined as six \textcircled{6}. The total number of pressure measurements recorded during the second segment of wave 51, and identified below the 1^{st} median-pressure 57, is determined as four \textcircled{4}. The asymmetry in the total number of pressure measurements across the entire pressure wave 51, when comparing the counts from above and below the 1^{st} median-pressure 57; being forty-two (42) pressure measurements located within the high-pressure section, and thirty-three (33) pressure measurements located within the low-pressure section; resulting in bias of nine (9) pressure measurements located within the high-pressure section, above the 1^{st} median-pressure 57.

Relying solely on this asymmetrical number of pressures above and below 1^{st} median-pressure 57, and to further average those asymmetrical values into a single pressure value for a respective strut, will generate a significantly heavier and invalid measurement of the aircraft's true-weight. To return symmetry to the averaging process, nine (9) of the high-pressure measurements are deducted from the total number of high-pressure measurements, to balance the number and symmetry above and below 1^{st} median line 57, resulting in the averaging of the thirty-three (33) pressure measurements located on either side of 1^{st} median-pressure 57. To avoid arbitrary removal of any of the discarded nine (9) specific pressure measurements, the respective nine (9) pressure measurements to be discarded are chosen by selecting those pressure measurements recorded which are nearest to the equivalency of the average pressure of all the pressures recorded nearest to 1^{st} median-pressure line 57; thus the selected pressures to be removed will not re-bias the overall average. Equalizing the number of high-pressure measurements to that of low-pressure measurements will re-balance the curve for wave 51 and remove the Earth's gravity bias. This alternate method to filter and remove the gravity bias does not require the use of data recorded by the multi-axis accelerometer 21 (shown in FIG. 3a) but is merely a novel process to re-establish symmetry throughout the averaging process. This second method can also be used as a cross-check function, for use of both first and second methods in parallel, to determine similar aircraft weight results, thus validating both methods.

The essential methods of this new invention are the progressions though software learning algorithms, herein shown by Example: to initially determine an initial static breakout friction value for MLG strut 5 while compressing, as the aircraft loads additional weight (being: 94 psi×50%=47 psi); further recognizing from previously identified asymmetrical frictional patterns, determined while the aircraft was in motion, that additional frictional forces are supporting some portion of the added weight, as strut 5 is telescopically compressing; thus providing a falsely lower pressure as related to the true-weight supported. Beyond the determination of the initial breakout friction correction values, to further identifying a subsequent pressure correction value (being: 94 psi×50%=47 psi+2 psi=49 psi) then application of the subsequent pressure correction value increase of 49 psi to strut pressure, as shown by the difference between measured pressure values along lower-line 53 (shown in FIG. 4b) determined while the aircraft is in motion, to that of the identified unfiltered 1^{st} mean-pressure line 71.

The subsequent 49 psi pressure correction value is applied to a respective strut of the stationary aircraft, when the struts are determined as telescopically compressing, identified with increasing measurements of strut pressure,

As weight is removed from the aircraft, with pressures decreasing due to struts telescopically extending, an opposing pressure correction value of 45 psi (being: 94 psi×50%=47 psi−2 psi=45 psi) to strut pressure, for a stationary aircraft.

Additional conventional methods of determining weight, such as those comprising the strain-gauge sensor monitoring of this invention progress though other learning software algorithms to subsequently compare the weight determined while the aircraft was stationary to an immediately measured weight of the aircraft while in motion, which is considered a more accurate weight determination, to identify any differences between the determination made while the aircraft is stationary, to that of the aircraft now in motion. With any identified differences, further used to improve subsequent weight measurements of the aircraft while stationary.

Additional methods of this invention provide for progressing though additional re-learning algorithms to continuously compare the determined static breakout friction values, and the dynamic friction values; as those friction values change throughout the wear-life of the telescopically mating-surfaces of the landing gear strut, with extensive periods of piston travel over to the seals and bearings within the landing gear strut cylinder; each and both friction correction values are compared to the subsequent testing of weight determinations at each respective strut, related to the previously applied pressure correction values to the stationary aircraft; with such continued testing now comparing weight determinations at each respective strut from the stationary aircraft, related to those respective weight measurements of the aircraft now in motion. Pressure correction values will progressively provide better accuracy through discovery by the afore mentioned “testing processes and subsequent re-testing” to continuously improved strut pressure correction values to provide the best opportunity to apply the most current and best available pressure correction values to each of the respective struts, on a subsequent request for weight measurement from the stationary aircraft.

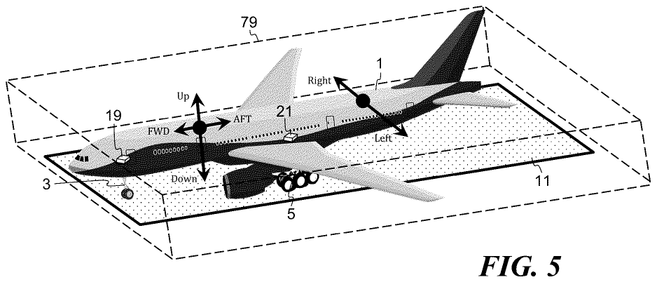

Referring now to FIG. 5, there is shown aircraft 1 proceeding along a taxiway, built upon the ground 11; where aircraft 1 is suspended atop the 3-pockets of compressed gas within three respective landing gear, and floating within a 3-dimensional space shown as a “virtual” cube 79, of 3-axis acceleration. Multi-axis accelerometers 19 and 21 measure all movements of aircraft 1, and movements are recorded as “g-forces” both positive and negative. The processes described in FIGS. 4a, 4b and 4c of tagging the vertical accelerations, measured as g-forces, to recorded strut pressures, are matched with the inclusion of horizontal accelerations measurements for both forward “FWD” and back “AFT”, accompanied with horizontal accelerations measurements from side to side “right and left.” Blending of the 3-axis accelerations allows for measurement of aircraft pitch, roll and ground speed (further identifying the aircraft while in motion) as the aircraft rocks back and forth, transferring the suspended load longitudinally between the NLG 3, and MLGs 5 and 7 (MLG 7 not shown); and laterally between the opposing left-MLG 5 and right-MLG 7 (shown in FIG. 1). Accelerometer 21 is located near the center of aircraft 1, near the MLG 5 position. An additional accelerometer 19 may also be used and positioned in the forward area of aircraft 1, near NLG 3.

Identifying aircraft 1 within a state of “net-zero” or near “net-zero” vertical and horizontal acceleration is the optimum time to capture strut pressure measurements, while the respective struts have the least amount of pressure distortions from positive or negative acceleration, and experiencing only the lesser pressure distortions of the “sliding” dynamic friction; as opposed to the greater pressure distortions experienced when overcoming “static” breakout friction during a reversal of strut pressure.

The more accurate weight determinations, identified when measuring total weight of the aircraft in motion; is determined by summing of the respective weights measured from NLG 3 and MLGs 5 and 7. The determined weights supported at each respective strut while the aircraft is in motion; are recorded and stored within a different level of the multi-dimensional and cross-referenced look-up tables, and compared against respective NLG and MLGs determined weights, previously applied while the aircraft was stationary. Those determined and respective differences in weight determinations, from to each respective NLG and MLG struts are stored within different and subordinate look-up tables, to draw upon later, to provide a better and more accurate strut pressure adjustment to the next weight request from that stationary aircraft, having those same landing gear struts.

Referring now to FIG. 6, there is shown an Apparatus Block Diagram illustrating the various components which make up the apparatus of the invention, where multiple (NLG, left-MLG and right-MLG) upper pressure/temperature sensors 27 and lower pressure/temperature sensors 29, along with aircraft inclinometer 15, and with forward NLG accelerometer 19 and a mid-aircraft MLG accelerometer 21, external temperature/humidity sensor 17, and multiple (NLG, left-MLG and right-MLG) load measuring strain-gauge sensors 39; which are all sources of data input into DACU 13.

Errors in determining aircraft weight using strut pressure, due to changes in the landing gear's static breakout frictional force patterns can range from factors such as:
Increased seal friction, induced by greater aircraft weight, resulting in higher internal strut pressure, further inducing higher levels of strut seal deformation (typical in seal designs) to maintain the internal fluid containment,
Increased seal friction induced by lower humidity and/or drier strut component mating-surfaces,
Increased seal friction induced by changes in temperatures, causing a change in the pliability of the seals,
Decreased seal friction induced by lower aircraft weight resulting in lower strut internal pressure,
Decreased seal friction induced by higher humidity and the added lubrication offered by moisture to strut component surfaces, or hydraulic fluid residue on the surface of the strut piston,
Decreased seal friction induced by changes in temperatures,
Aircraft vertical acceleration, amplifying the transition from static breakout friction to the lesser dynamic sliding friction.

These higher and lower ranges of delta pressure are typical, but aircraft do not always operate with similar weight values nor in constant environmental conditions. Continual trending of the various sensor data patterns and the further discovery of unexpected patterns in higher ranges of delta pressure will often result from atypical friction patterns, induced by factors such as:
Scarring or damage to the chrome finishes on the strut piston, which telescopically slides in and out of the strut cylinder.
Additional binding within the various bearings of the landing gear strut torque-link mechanisms, when the aircraft had been turning, thus applying twists to the strut piston, just as the aircraft becomes stationary. Monitoring the 3-axis acceleration of the aircraft hull as the aircraft transitions from moving, to stationary, can offer additional information, when comparison and identification of significant differences in static breakout friction values, identified from the opposing MLGs.
Additional binding from damage to a strut seal, piston wiper, piston scraper, and/or cylinder gland nut.

Though any and all of the possibilities listed above can change the delta pressure as measured while the aircraft taxi, they all are measured, monitored and further trended to better determine the pressure correction value to be properly applied while the aircraft is at a departure gate, stationary and at rest; to further calculate a more accurate breakout friction pressure correction value, to further determine the weight value at the next request for a weight determination, prior to the aircraft departing the gate.

The 12-step process for applying the current pressure correction values to a stationary aircraft, with continual learning from a moving aircraft, to improve future pressure correction values include:
1. Determine current strut pressure from the strut pressure sensor.
   Determine if strut pressure is increasing or decreasing, to further determine if strut is extending or collapsing, and to further determine appropriate positive or negative pressure correction for breakout friction.
   Refer to continually updated look-up table within the software of the DACU to determine appropriate “delta pressure” range for the current direction of strut movement
      Apply appropriate positive or negative breakout friction correction, for the current direction of strut movement; followed by application of additional adjustments for temperature and humidity.
2. Determine current internal strut temperature from the temperature sensor.
   Refer to look-up table to determine appropriate pressure adjustment value for current temperature.
      Apply appropriate pressure adjustment for current temperature.
3. Determine current external relative humidity from the humidity sensor.
   Refer to look-up table to determine appropriate pressure adjustment value for current humidity.
      Apply appropriate pressure adjustment for current humidity.
4. Make simultaneous calculations for all other respective landing gear.
5. Calculate the amount of sprung weight at each respective strut.
6. Add respective unsprung weight amounts to the sprung weight measurements.
7. Calculate and display the amount of total aircraft weight.
8. Calculate and display the aircraft CG.
9. Allow the aircraft to taxi.
10. Test the weight determination at each respective landing gear when the aircraft was stationary, by subsequent respective comparisons of weight determinations at each strut, while the aircraft is now in motion, during taxi.
11. From the identification of any differences between the respective friction correction values applied to the stationary aircraft, to that of the aircraft now in motion; calculate from the now discovered difference, a better friction correction value to be applied to each respective landing gear, at a subsequent (next) request for weight of the same stationary aircraft.
12. Repeat step 11 above, to allow the system to learn and re-learn, to provide ever-improving friction correction values associated with each respective landing gear strut.

Errors in determining aircraft weight when using strain-gauge sensors to measure deflection of the aircraft's respective load bearing components, can result in issues related to having only one (1) single snap-shot of the aircraft weight, while sitting stationary at an airport gate; and having an undetected weight error due to a variety of gusts from wind flowing across the aircraft wings, affecting not only the aircraft weight, but the distribution of that weight, measured as the aircraft center-of-gravity (CG). Other issues such as “electronic noise” within the system's processors and sensors; as well as winter-weather operations which can result in significant amounts of snow and ice being deposited onto the aircraft wings and fuselage, providing a false weight, until the aircraft taxi to the airport's de-icing station for its removal. The testing and subsequent taxi-period grading techniques described herein, offer methods to improve the aircraft's final weight measurements when using strain-gauge sensor methods and the like.

DACU 13 is equipped with an internal clock and calendar to document the time and date of recorded and stored data. DACU 13 has multiple software packages, which include:

### Software Program “Alpha”

which measure, record and time-stamp pressure and strain-gauge measurements from respective NLG, left-MLG and right-MLG struts.

### Software Program “Beta”

which measure, record and time-stamp 3-axis acceleration at positions near NLG, and combined left-MLG and right-MLG struts, in directions including:
   vertical
   horizontal—FWD and AFT
   horizontal—side to side

### Software Program “Gamma”

which is a continuation of Software Programs “Alpha” and “Beta” to further “tag” or designate all of the time-stamped pressure measurements with a corresponding vertical and horizontal acceleration value, as strut pressures transition through the wave of pressure oscillations during the aircraft taxi-period.

### Software Program “Delta”

which is a continuation of Software Program “Alpha” to further identify all recorded pressures along a pressure oscillation wave, and further determine the range of pressure between the highest high-peak pressure to that of the lowest low-peak pressure, herein referred to as the un-filtered delta-pressure.

### Software Program “Epsilon”

which is a continuation of Software Program “Delta” to further recognize and determine the Gravity induced longer period of elapsed time taken to complete a high-pressure reversal (identified as a pressure reversal “arc”) to that of the shorter period of elapsed time taken to complete a low-pressure reversal arc, along the oscillating pressure wave.

### Software Program “Zeta”

which is a continuation of Software Program “Delta” to further determine an un-filtered 1^{st} median-pressure 57 (described in FIG. 4b) by averaging the delta-pressure range, for each landing gear strut.

### Software Program “Eta”

which is a continuation of Software Program “Epsilon” to further recognize and correct for Earth's gravity bias, effecting aircraft taxiing at heavier weights and the associated higher pressures within the respective landing gear struts; which gravity induces more rounded pressure reversals in the oscillation curves, through the higher-pressure ranges (described in FIG. 4b). Recognizing the asymmetrically greater number of higher pressures and averaging of all pressures throughout the oscillation wave 51, to identify a higher 1^{st} mean-pressure 71 (shown in FIG. 4b).

### Software Program “Theta”

which is a continuation of Software Programs “Beta” and “Eta” to further discard respective pressures which are re-tagged with a vertical acceleration identified as excessive and outside of the determined band of acceptable acceleration values.

### Software Program “Iota”

which is a continuation of Software Program “Theta” to further identify respective pressures which are re-tagged with non-stabilized vertical and horizontal accelerations, which are outside of the determined band of acceptable acceleration values; to determine those pressure measurements which are identified as acceptable and captured during the brief period while the aircraft maintains a state of near-neutral vertical and horizontal acceleration, and categorized as “filtered” pressures; to further determine a 2^{nd} median-pressure 77 (shown in FIG. 4c) being a value determined by averaging the highest and lowest “filtered” pressure limits values, now as the reduced delta-pressure range.

### Software Program “Kappa”

which is a continuation of Software Program “Iota” to further average all re-tagged and filtered pressures, to identify a 2^{nd} mean-pressure 75 (shown in FIG. 4c).

### Software Program “Lambda”

which is a continuation of Software Program “Zeta” to further recognize the aircraft taxiing at heavier weights and the associated higher pressures within the respective landing gear struts; recognizing a pressure range asymmetry, by having a greater number of above-median pressures compared to below-median pressures; to then discard the identified number of above-median pressure measurements in excess of the number of below-median pressure measurements, to achieve symmetry in the number of above-median pressure and below-median pressure measurements, then averaging of all remaining non-discarded pressures throughout the oscillation wave to allow an alternate method to increase accuracy.

### Software Program “Mu”

which is a continuation of Software Programs “Eta” and “Kappa” which identifies the range of measured strut pressure, and direction of a most recent change in pressure, either increasing or decreasing; to correct for determined differences in the frictional force distortions to strut pressure, and changes to the frictional force values; related to the determined, periodically corrected and revised “friction-fingerprint” of respective landing gear friction, stored within a short-term memory look-up table as the developed and continually revised and updated strut frictional-fingerprint data-base.

### Software Program “Nu”

which monitors data from inclinometer 15 to measure changes in the angle of aircraft inclination (FWD-AFT), as an additional input to correct for aircraft angle being un-level with that of the ground 11 (Shown in FIG. 1).

### Software Program “Xi”

which applies into software algorithms, the pre-determined landing gear strut pressure correction values associated with each of the respective telescopic landing gear, to further determine a revised landing gear strut pressure correction value for pressure distortions induced by frictional forces, to further process and measure the “sprung weight” in combination with determined “un-sprung weight” for an ultimate determination of corrected weight supported by a respective landing gear.

### Software Program “Omicron”

which immediately tests the accuracy of the just-applied and respective strut pressure correction values, by comparing the just-determined “sprung weight” values determined at each landing gear, while the aircraft had been stationary; to those respective new and now-determined “sprung weight” values determined as the aircraft will taxi away from a gate, with the aircraft now in motion.

### Software Program “Pi”

which immediately grades, evaluates and determines the validity of the just-applied friction correction values from Software Program Xi; by comparing the respective friction correction values just-applied to the stationary aircraft obtained from values pre-stored within a look-up table, and further monitoring each of the oscillating landing gear pressure patterns, to determine if a more accurate pressure correction value can be identified as now determined while the aircraft is in motion. To further determine from the analysis of the frictional patterns of the moving aircraft, a better and more accurate friction correction value; to subsequently apply the newly-determined as better correction values stored within a short-term memory look-up table, be applied to the next request for weight, of the stationary aircraft.

### Software Program “Rho”

which further determines, from comparative analysis of the frictional patterns of the moving aircraft to those previously selected from the look-up table, then applied to determine the weight of the stationary aircraft. When a better and more accurate friction correction value is determined; to subsequently apply this newly-determined as superior correction values, for use and application to the next request for weight of the stationary aircraft.

### Software Program “Sigma”

which applies the newly-learned and superior friction correction values, to the next and subsequent requests for measurement of the weight, from a stationary aircraft.

### Software Program “Tau”

which applies the similar newly-learned and superior weight correction values, to those determinations of the weight measured by strain-gauge sensors, for a stationary aircraft; to identify and correct for systemic electronic errors, as well as operational and environmental errors occurring during winter-weather operations.

In certain preferred embodiments, an aircraft operation method is provided to improve aircraft weight information, the aircraft having plural landing gear struts, that collectively support a total weight of the aircraft, each landing gear strut having sensors which measure respective strut loads to determine a respective weight supported at each landing gear strut, the method comprising the steps of:
a. while the aircraft is in a first stationary position, obtaining first respective static weights supported at each of the respective landing gear struts, and determining a static weight of the aircraft, the static weight of the aircraft being a weight of the aircraft while the aircraft is in the first stationary position;
b. causing the aircraft to perform a first taxi maneuver;
c. during the first taxi maneuver, obtaining first respective dynamic weights at each landing gear strut, and, using the obtained first respective landing gear strut dynamic weights, determining a first total aircraft weight, the first total weight being a dynamic weight of the aircraft supported by the landing gear struts during the first taxi maneuver;
d. for each respective landing gear strut, identifying a respective first-adjustment value which corrects for first respective weight difference at each landing gear strut, and, storing the respective first-adjustment values within a look-up table;
e. thereafter, and while the aircraft is in a second stationary position, obtaining second respective static weights of the respective landing gear struts, and, referencing the look-up table and applying the respective first-adjustment values to the respective obtained static weights, determining a second and adjusted static weight of the aircraft, the second and adjusted static weight of the aircraft being a weight of the aircraft while the aircraft is in the second stationary position;
f. causing the aircraft to perform a second taxi maneuver;
g. during the second taxi maneuver, obtaining second respective dynamic weights at each landing gear strut, and using the obtained second respective dynamic landing gear strut weights, determining a second total aircraft weight, the second total weight being a dynamic weight of the aircraft supported by the landing gear struts during the second taxi maneuver;
h. repeating the steps a.-g. for the subsequent aircraft, such that the look-up table is updated with improved learnings of subsequent-adjustment values.

In certain embodiments of the foregoing aircraft operation method, the sensors comprise at least one pressure sensor.

In certain preferred embodiments, an aircraft operation method is provided to improve aircraft weight information, the aircraft having plural pressurized telescopic landing gear struts that collectively support a total weight of the aircraft, each landing gear strut having internal seals and guide bearings, the seals and bearings creating friction that interferes with free telescoping movement of the landing gear, which distort strut pressure in relation to a weight supported at each landing gear strut, the method comprising the steps of:
a. causing the aircraft to perform a first taxi maneuver;
b. during the first taxi maneuver, obtaining first respective landing gear strut pressures, and, using the obtained first respective landing gear strut pressures, determining a first weight, the first weight being a dynamic weight of the aircraft supported by the struts during the first taxi maneuver;
c. for each respective landing gear strut, identifying a respective first-adjustment value which corrects for first respective frictional interference distortions in each strut, and, storing the respective first-adjustment values within a look-up table;
d. thereafter, and while the aircraft is in a stationary position, obtaining respective static pressures of the respective landing gear struts, and, referencing the look-up table and applying the respective first-adjustment values to the respective obtained static pressures, determining a static weight of the aircraft, the static weight of the aircraft being a total weight of the aircraft while the aircraft is in the stationary position;
e. causing the aircraft to perform a second taxi maneuver;
f. during the second taxi maneuver, obtaining second respective landing gear strut pressures, and, using the obtained second respective landing gear strut pressures, determining a second weight, the second weight being a total dynamic weight of the aircraft supported by the landing gear struts during the second taxi maneuver;
g. comparing the obtained respective static pressures to the obtained second respective strut pressures, and, identifying a difference between the respective strut and total static weight and the second respective strut and total weight;
h. using the identified difference between the static weight and the second weight, identifying a respective second-adjustment value which corrects for respective second frictional interference distortions in each landing gear strut, and storing the respective second-adjustment values in the look-up table for use during a subsequent set of weight determinations for a subsequent aircraft in a stationary position;
i. repeating the steps a.-h. for the subsequent aircraft such that the look-up table is updated with improved learnings of subsequent-adjustment values.

In certain preferred embodiments, an aircraft operation method is provided to improve aircraft weight information, the aircraft being equipped with a strain-gauge design OnBoard Weight and Balance System (OBWBS) and landing gear struts that collectively support a total weight of the aircraft, the method comprising the steps of:
a. causing the OBWBS to provide a static weight for the aircraft while stationary;
b. causing the aircraft to perform a first taxi maneuver;
c. during the first taxi maneuver, determining a first weight, the first weight being a dynamic weight of the aircraft supported by the landing gear struts during the first taxi maneuver;
d. identifying a first weight adjustment value which corrects for errors identified when compared to the static weight measurement;
e. causing the aircraft to perform a second taxi maneuver;
f. during the second taxi maneuver, determining a second weight, the second weight being a dynamic weight of the aircraft supported by the landing gear struts during the second taxi maneuver;
g. comparing the obtained respective static weight to the obtained second weight, and, identifying a difference between the static weight and the second weight;
h. using the identified difference between the static weight and the second weight, identifying a respective second-adjustment value which corrects for respective weight differences, and storing the respective second-adjustment values in the look-up table for use during a subsequent set of weight determinations for a subsequent aircraft;
i. repeating the steps a.-h. for the subsequent aircraft such that the look-up table is updated with improved learnings of subsequent-adjustment values.

The present invention has been described as adding additional computer and software methods, accompanied with features of the prior art apparatus and methods of using landing gear strut pressure when measuring aircraft weight; to improve the accuracy for determination of the weight of a stationary aircraft, with such embodiments attached to telescopic elements, of oleo type aircraft landing gear struts, the invention could also apply to other types of industrial telescopic devices.

Additionally, as an exemplary embodiment of the invention has been disclosed and discussed, it will be understood that other applications of the invention are possible and that the embodiment disclosed may be subject to various changes, modifications, and substitutions without necessarily departing from the spirit and scope of the invention.

1. An aircraft operation method to improve aircraft weight information, the aircraft having plural landing gear struts, that collectively support a total weight of the aircraft, each landing gear strut having sensors which measure respective strut loads to determine a respective weight supported at each landing gear strut, the method comprising the steps of:
a. while the aircraft is in a first stationary position, obtaining a first respective static weight supported at each of the respective landing gear struts, and determining a static weight of the aircraft, the static weight of the aircraft being a weight of the aircraft while the aircraft is in the first stationary position;
b. causing the aircraft to perform a first taxi maneuver;
c. during the first taxi maneuver, obtaining first respective dynamic weights at each landing gear strut, and, using the obtained first respective landing gear strut dynamic weights, determining a first total aircraft weight, the first total weight being a dynamic weight of the aircraft supported by the landing gear struts during the first taxi maneuver;
d. for each respective landing gear strut, identifying a respective first-adjustment value which corrects for first respective weight difference at each landing gear strut, and, storing the respective first-adjustment values within a look-up table;
e. thereafter, and while the aircraft is in a second stationary position, obtaining second respective static weights of the respective landing gear struts, and, referencing the look-up table and applying the respective first-adjustment values to the respective obtained static weights, determining a second and adjusted static weight of the aircraft, the second and adjusted static weight of the aircraft being a weight of the aircraft while the aircraft is in the second stationary position;
f. causing the aircraft to perform a second taxi maneuver;
g. during the second taxi maneuver, obtaining second respective dynamic weights at each landing gear strut, and using the obtained second respective dynamic landing gear strut weights, determining a second total aircraft weight, the second total weight being a dynamic weight of the aircraft supported by the landing gear struts during the second taxi maneuver;
h. repeating the steps a.-g. for the subsequent aircraft such that the look-up table is updated with improved learnings of subsequent-adjustment values.

2. The aircraft operation method of claim 1, wherein the sensors comprise at least one pressure sensor.

3. The aircraft operation method of claim 1, wherein the sensors comprise at least one strain-gauge sensor.

4. An aircraft operation method to improve aircraft weight information, the aircraft having plural pressurized telescopic landing gear struts that collectively support a total weight of the aircraft, each landing gear strut having internal seals and guide bearings, the seals and bearings creating friction that interferes with free telescoping movement of the landing gear, which distort strut pressure in relation to a weight supported at each landing gear strut, the method comprising the steps of:
a. causing the aircraft to perform a first taxi maneuver;
b. during the first taxi maneuver, obtaining first respective landing gear strut pressures, and, using the obtained first respective landing gear strut pressures, determining a first weight, the first weight being a dynamic weight of the aircraft supported by the struts during the first taxi maneuver;
c. for each respective landing gear strut, identifying a respective first-adjustment value which corrects for first respective frictional interference distortions in each strut, and, storing the respective first-adjustment values within a look-up table;
d. thereafter, and while the aircraft is in a stationary position, obtaining respective static pressures of the respective landing gear struts, and, referencing the look-up table and applying the respective first-adjustment values to the respective obtained static pressures, determining a static weight of the aircraft, the static weight of the aircraft being a total weight of the aircraft while the aircraft is in the stationary position;
e. causing the aircraft to perform a second taxi maneuver;
f. during the second taxi maneuver, obtaining second respective landing gear strut pressures, and, using the obtained second respective landing gear strut pressures, determining a second weight, the second weight being a total dynamic weight of the aircraft supported by the landing gear struts during the second taxi maneuver;
g. comparing the obtained respective static pressures to the obtained second respective strut pressures, and, identifying a difference between the total static weight and the second weight;
h. using the identified difference between the static weight and the second weight, identifying a respective second-adjustment value which corrects for respective second frictional interference distortions in each landing gear strut, and storing the respective second-adjustment values in the look-up table for use during a subsequent set of weight determinations for a subsequent aircraft in a stationary position;
i. repeating the steps a.-h. for the subsequent aircraft such that the look-up table is updated with improved learnings of subsequent-adjustment values.

5. An aircraft operation method to improve aircraft weight information, the aircraft being equipped with a strain-gauge design OnBoard Weight and Balance System (OBWBS) and landing gear struts that collectively support a total weight of the aircraft, the method comprising the steps of:
a. causing the OBWBS to provide a static weight for the aircraft while stationary;
b. causing the aircraft to perform a first taxi maneuver;
c. during the first taxi maneuver, determining a first weight, the first weight being a dynamic weight of the aircraft supported by the landing gear struts during the first taxi maneuver;
d. identifying a first weight adjustment value which corrects for errors identified when compared to the static weight measurement;
e. causing the aircraft to perform a second taxi maneuver;
f. during the second taxi maneuver, determining a second weight, the second weight being a dynamic weight of the aircraft supported by the landing gear struts during the second taxi maneuver;
g. comparing the obtained respective static weight to the obtained second weight, and, identifying a difference between the static weight and the second weight;
h. using the identified difference between the static weight and the second weight, identifying a respective second-adjustment value which corrects for respective weight differences, and storing the respective second-adjustment values in the look-up table for use during a subsequent set of weight determinations for a subsequent aircraft;
i. repeating the steps a.-h. for the subsequent aircraft such that the look-up table is updated with improved learnings of subsequent-adjustment values.
